(19) United States
(12) Patent Application Publication
(10) Pub. No.: US 2023/0096818 A1
(43) Pub. Date: Mar. 30, 2023

(54) POWER SOURCE UNIT FOR AEROSOL INHALER

(71) Applicant: JAPAN TOBACCO INC., Tokyo (JP)

(72) Inventor: Takuma NAKANO, Tokyo (JP)

(73) Assignee: JAPAN TOBACCO INC., Tokyo (JP)

(21) Appl. No.: 18/071,112

(22) Filed: Nov. 29, 2022

Related U.S. Application Data
(63) Continuation of application No. PCT/JP2020/046438, filed on Dec. 11, 2020.

(51) Int. Cl. A24F 40/57; A24F 40/10; A24F 40/20; A24F 40/30; A24F 40/53; A24F 40/65; H05B 1/02

(52) U.S. Cl. CPC A24F 40/57; A24F 40/10; A24F 40/20; A24F 40/30; A24F 40/53; A24F 40/65; H05B 1/0244

(57) ABSTRACT

A power source unit, for an aerosol inhaler causing a flavor source to pass through an aerosol generated by heating an aerosol source to add a flavor component of the flavor source to the aerosol, includes: a power source discharging to a first load which is a load for heating the aerosol source and a second load which is a load for heating the flavor source; and a control device controlling discharge from the power source to a control target load including at least one of the first load and the second load. The control device includes a plurality of control profiles, controls the discharge to the control target load, is able to change the control profile used for controlling the discharge to the control target load based on a change instruction from a user, and limits the change of the control profile during discharge to the first load.

### CROSS REFERENCE TO RELATED APPLICATION(S)

This application is a continuation of International Patent Application No. PCT/JP2020/046438 filed on Dec. 11, 2020, the content of which is incorporated herein by reference.

### TECHNICAL FIELD

The present disclosure relates to a power source unit for an aerosol inhaler.

### BACKGROUND ART

JP-A-2017-511703 describes a device capable of adding, by passing an aerosol generated by heating a liquid through a flavor source, a flavor component contained in the flavor source to the aerosol, and allowing a user to inhale the aerosol containing the flavor component. WO 2019/104227A1 describes an inhalation device capable of changing a heating profile of a heater.

When a user is allowed to change a control profile used for controlling discharge from a power source to a load for heating an aerosol source or a flavor source, the user can change a generation amount of an aerosol or an amount of a flavor component to be added to the aerosol through the change of the control profile. Therefore, it is considered that if the control profile can be appropriately changed, the user can obtain a desired fragrance inhaling taste, and the marketability of the aerosol inhaler is improved.

However, on the other hand, the change of the control profile may cause an uncomfortable feeling to the user or reduce the fragrance inhaling taste.

The present disclosure provides a power source unit capable of appropriately changing a control profile and improving the marketability of an aerosol inhaler.

### SUMMARY

A first aspect of the present disclosure relates to a power source unit for an aerosol inhaler causing a flavor source to pass through an aerosol generated by heating an aerosol source to add a flavor component of the flavor source to the aerosol, the power source unit including: a power source capable of discharging to a first load which is a load for heating the aerosol source and a second load which is a load for heating the flavor source; and a control device that controls discharge from the power source to a control target load including at least one of the first load and the second load, in the power source unit, where: the control device includes a plurality of control profiles, controls the discharge to the control target load based on any one of the plurality of control profiles; the control device is able to change the control profile used for controlling the discharge to the control target load based on a change instruction from a user; and the control device limits the change of the control profile during discharge to the first load.

A second aspect of the present disclosure relates to a power source unit for an aerosol inhaler causing a flavor source to pass through an aerosol generated by heating an aerosol source to add a flavor component of the flavor source to the aerosol, the power source unit including: a power source capable of discharging to a load for heating the aerosol source; and a control device that controls discharge from the power source to a control target load including the load, in the power source unit, where: the control device includes a plurality of control profiles, controls the discharge to the control target load based on any one of the plurality of control profiles; the control device is able to change the control profile used for controlling the discharge to the control target load based on a change instruction from a user; and the control device limits the change of the control profile during discharge to the load.

A third aspect of the present disclosure relates to a power source unit for an aerosol inhaler causing a flavor source to pass through an aerosol generated by heating an aerosol source to add a flavor component of the flavor source to the aerosol, the power source unit including: a power source capable of discharging to a load for heating the flavor source; and a control device that controls discharge from the power source to a control target load including the load, in the power source unit, where: the control device includes a plurality of control profiles, controls the discharge to the control target load based on any one of the plurality of control profiles; the control device is able to change the control profile used for controlling the discharge to the control target load based on a change instruction from a user; and the control device limits the change of the control profile during discharge to the load.

According to the present disclosure, it is possible to provide a power source unit capable of appropriately changing a control profile and improving the marketability of an aerosol inhaler.

### BRIEF DESCRIPTION OF DRAWINGS

FIG. 1 is a perspective view schematically illustrating a schematic configuration of an aerosol inhaler;

FIG. 2 is another perspective view of the aerosol inhaler in FIG. 1;

FIG. 3 is a cross-sectional view of the aerosol inhaler in FIG. 1;

FIG. 4 is a perspective view of a power source unit in the aerosol inhaler in FIG. 1;

FIG. 5 is a schematic diagram illustrating a hardware configuration of the aerosol inhaler in FIG. 1;

FIG. 6 is a diagram illustrating a specific example of a power source unit illustrated in FIG. 5;

FIG. 7 is a diagram illustrating a specific example of a control profile in the aerosol inhaler in FIG. 1;

FIG. 8 is a flow chart (No. 1) for illustrating operations of the aerosol inhaler in FIG. 1 during aerosol generation;

FIG. 9 is a flow chart (No. 2) for illustrating operations of the aerosol inhaler in FIG. 1 during the aerosol generation; and

FIG. 10 is a flowchart for illustrating operations of changing the control profile in the aerosol inhaler in FIG. 1.

### DESCRIPTION OF EMBODIMENTS

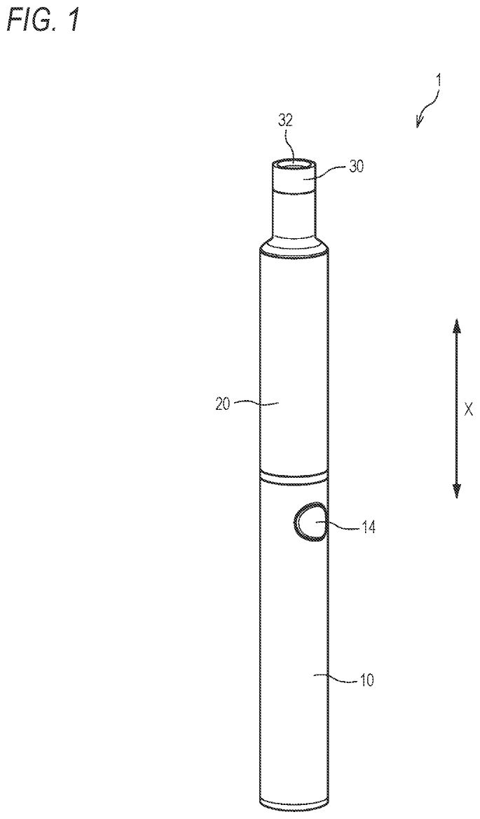

Hereinafter, an aerosol inhaler 1, which is an embodiment of an aerosol inhaler of the present disclosure, will be described with reference to FIGS. 1 to 5.

(Aerosol Inhaler)

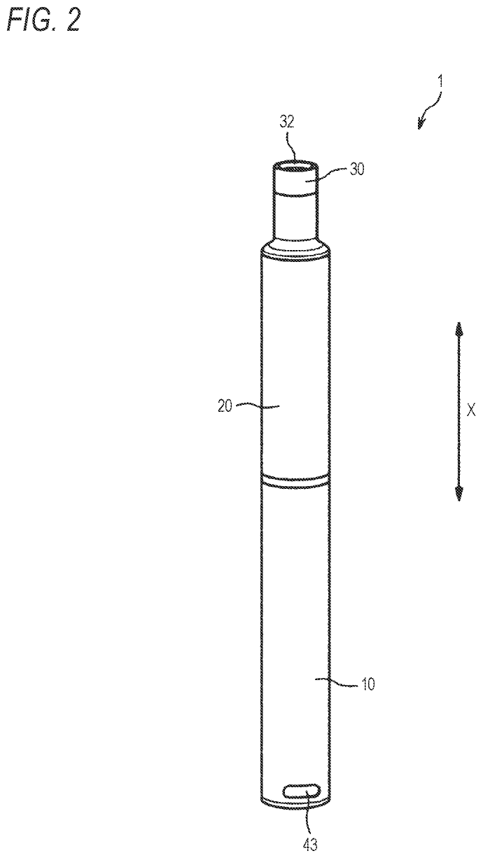

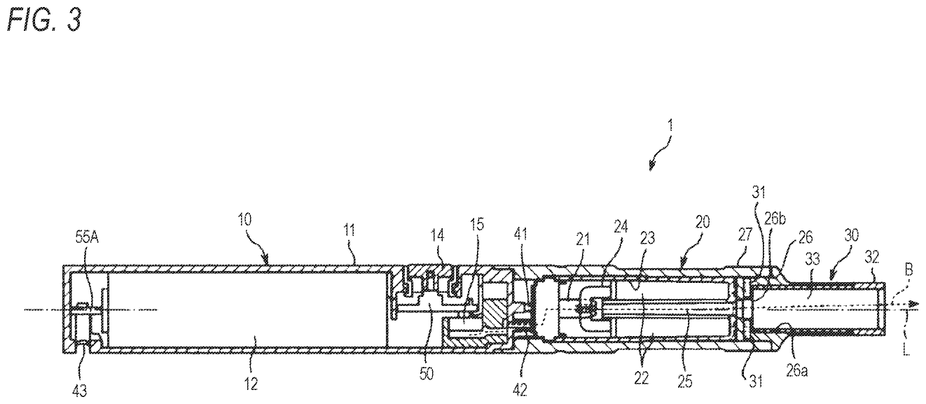

The aerosol inhaler 1 is an instrument for generating an aerosol to which a flavor component is added without combustion, and allowing the aerosol to be inhaled, and has a rod shape that extends along a predetermined direction (hereinafter, referred to as a longitudinal direction X) as illustrated in FIGS. 1 and 2. In the aerosol inhaler 1, a power source unit 10, a first cartridge 20, and a second cartridge 30 are provided in this order along the longitudinal direction X. The first cartridge 20 is attachable to and detachable from (in other words, replaceable with respect to) the power source unit 10. The second cartridge 30 is attachable to and detachable from (in other words, replaceable with respect to) the first cartridge 20. As illustrated in FIG. 3, the first cartridge 20 is provided with a first load 21 and a second load 31. An overall shape of the aerosol inhaler 1 is not limited to a shape in which the power source unit 10, the first cartridge 20, and the second cartridge 30 are arranged in a line as illustrated in FIG. 1. Any shape such as a substantially box shape can be adopted as long as the first cartridge 20 and the second cartridge 30 are replaceable with respect to the power source unit 10. The second cartridge 30 may be attachable to and detachable from (in other words, replaceable with respect to) the power source unit 10.

(Power Source Unit)

As illustrated in FIGS. 3, 4, and 5, the power source unit 10 accommodates, inside a cylindrical power source unit case 11, a power source 12, a charging IC 55A, a micro controller unit (MCU) 50, a DC/DC converter 51, an inhalation sensor 15, a temperature detection element T1 including a voltage sensor 52 and a current sensor 53, and a temperature detection element T2 including a voltage sensor 54 and a current sensor 55.

The power source 12 is a rechargeable secondary battery, an electric double layer capacitor or the like, and is preferably a lithium ion secondary battery. An electrolyte of the power source 12 may include one of a gel-like electrolyte, an electrolytic solution, a solid electrolyte, and an ionic liquid, or a combination thereof.

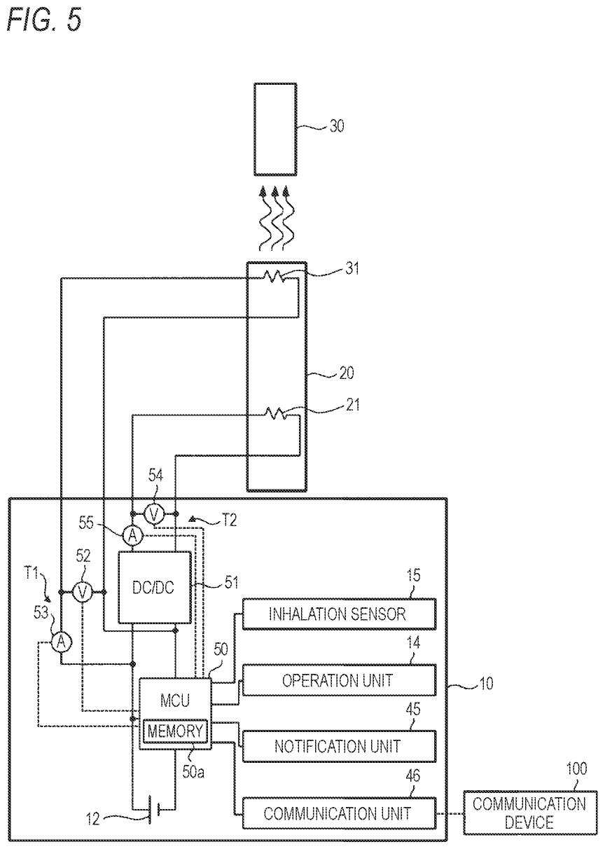

As illustrated in FIG. 5, the MCU 50, which is an example of a control device, is connected to various sensor devices such as the inhalation sensor 15, the voltage sensor 52, the current sensor 53, the voltage sensor 54, and the current sensor 55, and the DC/DC converter 51, an operation unit 14, a notification unit 45, and a communication unit 46, and performs various controls of the aerosol inhaler 1.

Specifically, the MCU 50 is mainly implemented by a processor, and further includes a memory 50a implemented by a storage medium such as a random access memory (RAM) necessary for an operation of the processor and a read only memory (ROM) for storing various kinds of information. Specifically, the processor in the present description is an electric circuit in which circuit elements such as semiconductor elements are combined.

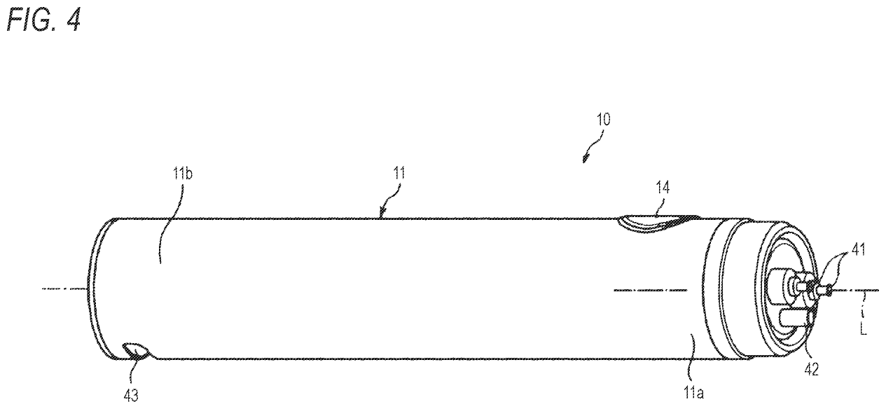

As illustrated in FIG. 4, a discharge terminal 41 is provided on a top portion 11a located on one end side (first cartridge 20 side) of the power source unit case 11 in the longitudinal direction X. The discharge terminal 41 is provided so as to protrude from an upper surface of the top portion 11a toward the first cartridge 20, and can be electrically connected to each of the first load 21 and the second load 31 of the first cartridge 20.

In addition, an air supply portion 42 that supplies air to the first load 21 of the first cartridge 20 is provided in the vicinity of the discharge terminal 41 on the upper surface of the top portion 11a.

A charging terminal 43 that can be electrically connected to an external power source (not illustrated) is provided in a bottom portion 11b located on the other end side (a side opposite to the first cartridge 20) of the power source unit case 11 in the longitudinal direction X. The charging terminal 43 is provided on a side surface of the bottom portion 11b, and can be connected to, for example, a universal serial bus (USB) terminal, a micro USB terminal, or the like.

The charging terminal 43 may be a power receiving unit capable of receiving power transmitted from the external power source in a wireless manner. In such a case, the charging terminal 43 (power receiving unit) may be implemented by a power receiving coil. A wireless power transfer system may be an electromagnetic induction system, a magnetic resonance system, or a combination thereof. In addition, the charging terminal 43 may be a power receiving unit capable of receiving power transmitted from the external power source in a contactless manner. As another example, the charging terminal 43 can be connected to a USB terminal, a micro USB terminal, or the like, and may include the above-described power receiving unit.

In the power source unit case 11, the operation unit 14 operable by a user is provided on a side surface of the top portion 11a so as to face a side opposite to the charging terminal 43. More specifically, the operation unit 14 and the charging terminal 43 are in a relation of point symmetry with respect to an intersection between a straight line connecting the operation unit 14 and the charging terminal 43 and a center line of the power source unit 10 in the longitudinal direction X. The operation unit 14 includes a button-type switch, a touch panel, or the like.

As illustrated in FIG. 3, the inhalation sensor 15 that detects an inhalation (puff) operation is provided in the vicinity of the operation unit 14. The power source unit case 11 is provided with an air intake port (not illustrated) through which outside air is taken into the power source unit case 11. The air intake port may be provided in the periphery of the operation unit 14, or may be provided in the periphery of the charging terminal 43.

The inhalation sensor 15 outputs a value of a pressure (internal pressure) change in the power source unit 10 caused by an inhalation of the user through an inhalation port 32 to be described later. The inhalation sensor 15 is, for example, a pressure sensor that outputs an output value (for example, a voltage value or a current value) corresponding to the internal pressure that changes according to a flow rate of the air inhaled from the air intake port toward the inhalation port 32 (that is, the inhalation operation of the user). The inhalation sensor 15 may output an analog value, or may output a digital value converted from the analog value.

In order to compensate for a pressure to be detected, the inhalation sensor 15 may include a built-in temperature sensor that detects a temperature (outside air temperature) of an environment in which the power source unit 10 is placed. The inhalation sensor 15 may be implemented by a condenser microphone, a flow rate sensor, or the like instead of a pressure sensor.

When an inhalation operation is performed and an output value of the inhalation sensor 15 exceeds a threshold value, the MCU 50 determines that an aerosol generation request has been made, and thereafter, when the output value of the inhalation sensor 15 is smaller than the threshold value, the MCU 50 determines that the aerosol generation request has ended. In the aerosol inhaler 1, for a purpose of preventing overheating of the first load 21, when a period during which the aerosol generation request is made reaches a first predetermined value tᵤₚₚₑᵣ (for example, 2.4 seconds), it is determined that the aerosol generation request has ended regardless of the output value of the inhalation sensor 15. In this way, the output value of the inhalation sensor 15 is used as a signal indicating the aerosol generation request. Therefore, the inhalation sensor 15 constitutes a sensor that outputs an aerosol generation request.

Instead of the inhalation sensor 15, the aerosol generation request may be detected based on an operation of the operation unit 14. For example, when a user performs a predetermined operation on the operation unit 14 to start inhalation of an aerosol, the operation unit 14 may output a signal indicating the aerosol generation request to the MCU 50. In this case, the operation unit 14 constitutes a sensor that outputs the aerosol generation request.

The charging IC 55A is disposed close to the charging terminal 43, and controls charging of power input from the charging terminal 43 to the power source 12. The charging IC 55A may be disposed in the vicinity of the MCU 50.

(First Cartridge)

As illustrated in FIG. 3, the first cartridge 20 includes, inside a cylindrical cartridge case 27, a reservoir 23 that stores an aerosol source 22, the first load 21 for atomizing and/or vaporizing the aerosol source 22, a wick 24 that draws the aerosol source from the reservoir 23 to the first load 21, an aerosol flow path 25 through which the aerosol generated by the aerosol source 22 being atomized and/or vaporized by the first load 21 flows toward the second cartridge 30, an end cap 26 that accommodates a part of the second cartridge 30, and the second load 31 that is provided in the end cap 26 and used for heating the second cartridge 30.

The reservoir 23 is partitioned and formed so as to surround the periphery of the aerosol flow path 25, and stores (that is, accommodates) the aerosol source 22. A porous body such as a resin web or cotton may be accommodated in the reservoir 23, and the aerosol source 22 may be impregnated in the porous body. The reservoir 23 may store only the aerosol source 22 without accommodating the porous body such as a resin web or cotton. The aerosol source 22 contains a liquid such as glycerin, propylene glycol, or water. In addition, the aerosol source 22 may contain a flavor such as menthol.

The wick 24 is a liquid holding member that draws the aerosol source 22 from the reservoir 23 to the first load 21 utilizing a capillary action. The wick 24 is made of, for example, glass fiber or porous ceramic.

The first load 21 heats the aerosol source 22 by power supplied from the power source 12 via the discharge terminal 41 without combustion, thereby atomizing and/or vaporizing (hereinafter, simply referred to as atomizing) the aerosol source 22. The first load 21 is implemented by, for example, an electric heating wire (coil) wound at a predetermined pitch.

The first load 21 may be any element that can generate an aerosol by heating the aerosol source 22 and atomizing the aerosol source 22. The first load 21 is, for example, a heat generating element. Examples of the heat generating element include a heat generating resistor, a ceramic heater, an induction heating type heater, and the like.

As the first load 21, a load whose temperature and electric resistance value have a correlation is used. For example, as the first load 21, a load having a positive temperature coefficient (PTC) characteristic in which an electric resistance value increases as a temperature increases is used. Alternatively, a load having a negative temperature coefficient (NTC) characteristic in which an electric resistance value decreases as a temperature increases may be used as the first load 21.

The aerosol flow path 25 is provided on a center line L of the power source unit 10 on a downstream side of the first load 21. The end cap 26 includes: a cartridge accommodation portion 26a that accommodates a part of the second cartridge 30; and a communication path 26b that communicates the aerosol flow path 25 and the cartridge communication portion 26a.

The second load 31 is embedded in the cartridge accommodation portion 26a. The second load 31 heats the second cartridge 30 (more specifically, a flavor source 33 included therein) accommodated in the cartridge accommodation portion 26a by power supplied from the power source 12 via the discharge terminal 41. The second load 31 is implemented by, for example, an electric heating wire (coil) wound at a predetermined pitch.

The second load 31 may be an element that can heat the second cartridge 30. The second load 31 is, for example, a heat generating element. Examples of the heat generating element include a heat generating resistor, a ceramic heater, an induction heating type heater, and the like.

As the second load 31, a load whose temperature and electric resistance value have a correlation is used. For example, a load having a PTC characteristic is used as the second load 31. Alternatively, a load having a negative temperature coefficient (NTC) characteristic in which an electric resistance value decreases as a temperature increases may be used as the second load 31.

(Second Cartridge)

The second cartridge 30 stores (that is, accommodates) the flavor source 33. By heating the second cartridge 30 by the second load 31, the flavor source 33 stored in the second cartridge 30 is heated. The second cartridge 30 is accommodated in the cartridge accommodation portion 26a provided in the end cap 26 of the first cartridge 20 in an attachable and detachable manner. An end portion of the second cartridge 30 on the side opposite to the first cartridge 20 side serves as the inhalation port 32 for the user. The inhalation port 32 is not limited to be integrated with the second cartridge 30, and may also be attachable to and detachable from the second cartridge 30. By implementing the inhalation port 32 separately from the power source unit 10 and the first cartridge 20 in this way, the inhalation port 32 can be kept hygienic.

The second cartridge 30 adds the flavor component of the flavor source 33 to the aerosol by passing the aerosol, generated by the aerosol source 22 being atomized by the first load 21, through the flavor source 33. As raw material pieces that constitute the flavor source 33, cut tobacco or a molded body obtained by molding a tobacco raw material into particles can be used. The flavor source 33 may also be implemented by a plant other than tobacco (for example, mint, Chinese herb, and herb). The flavor source 33 may contain a flavor such as menthol.

The aerosol inhaler 1 generates an aerosol to which a flavor component is added by the aerosol source 22 and the flavor source 33. That is, the aerosol source 22 and the flavor source 33 constitute an aerosol generation source that generates an aerosol to which a flavor component is added.

The aerosol generation source in the aerosol inhaler 1 is a portion that is replaced and used by the user. The portion is provided to the user, for example, as a set of one first cartridge 20 and one or a plurality of (for example, five) second cartridges 30. The first cartridge 20 and the second cartridge 30 may be integrated into one cartridge.

In the aerosol inhaler 1 implemented in this way, air flowing in from an intake port (not illustrated) provided in the power source unit case 11 passes through the vicinity of the first load 21 of the first cartridge 20 from the air supply portion 42, as indicated by an arrow B in FIG. 3. The first load 21 atomizes the aerosol source 22 drawn from the reservoir 23 by the wick 24. An aerosol generated by the atomization flows through the aerosol flow path 25 together with the air flowing in from the intake port, and is supplied to the second cartridge 30 via the communication path 26b. The aerosol supplied to the second cartridge 30 passes through the flavor source 33 so as to add the flavor component thereto, and is supplied to the inhalation port 32.

The aerosol inhaler 1 is provided with the notification unit 45 that notifies various kinds of information (see FIG. 5). The notification unit 45 may be implemented by a light emitting element (including various displays), may be implemented by a vibration element, or may be implemented by a sound output element. The notification unit 45 may be implemented by a combination of two or more elements among the light emitting element, the vibration element, and the sound output element. For example, in the aerosol inhaler 1, the periphery of the operation unit 14 is translucent, and light is emitted by a light emitting element such as an LED constituting the notification unit 45.

The notification unit 45 may be provided in any one of the power source unit 10, the first cartridge 20, and the second cartridge 30, and is preferably provided in the power source unit 10 having the lowest replacement frequency in the aerosol inhaler 1. Accordingly, it is possible to reduce the manufacturing cost of the first cartridge 20 and the second cartridge 30, which have a higher replacement frequency than that of the power source unit 10, and to provide the first cartridge 20 and the second cartridge 30 to the user at low cost.

(Details of Power Source Unit)

As illustrated in FIG. 5, the DC/DC converter 51 is connected between the first load 21 and the power source 12 in a state where the first cartridge 20 is mounted on the power source unit 10. The MCU 50 is connected between the DC/DC converter 51 and the power source 12. The second load 31 is connected between the MCU 50 and the DC/DC converter 51 in a state where the first cartridge 20 is mounted on the power source unit 10. As described above, in the power source unit 10, the second load 31 and a series circuit of the DC/DC converter 51 and the first load 21 are connected in parallel to the power source 12 in a state where the first cartridge 20 is mounted.

The DC/DC converter 51 is a booster circuit capable of boosting and outputting an input voltage, and can supply the input voltage or a voltage obtained by boosting the input voltage to the first load 21. Since power to be supplied to the first load 21 can be adjusted by the DC/DC converter 51, an amount of the aerosol source 22 to be atomized by the first load 21 can be controlled. As the DC/DC converter 51, for example, a switching regulator that converts an input voltage into a desired output voltage by controlling an on/off time of a switching element while monitoring an output voltage can be used. When a switching regulator is used as the DC/DC converter 51, by controlling the switching element, an input voltage can be directly output without being boosted.

The MCU 50 can acquire a temperature of the flavor source 33 in order to control discharge to the second load 31 to be described later. In addition, the MCU 50 can preferably acquire a temperature of the first load 21. The temperature of the first load 21 can be used to prevent overheating of the first load 21 and the aerosol source 22 and to highly control an amount of the aerosol source 22 atomized by the first load 21.

The voltage sensor 52 measures a voltage value to be applied to the second load 31 and outputs the voltage value. The current sensor 53 measures a current value flowing through the second load 31 and outputs the current value. An output of the voltage sensor 52 and an output of the current sensor 53 are input to the MCU 50, respectively. The processor of the MCU 50 acquires a resistance value of the second load 31 based on the output of the voltage sensor 52 and the output of the current sensor 53, and acquires the temperature of the second load 31 corresponding to the resistance value. The temperature of the second load 31 does not strictly coincide with the temperature of the flavor source 33 heated by the second load 31, but can be regarded as substantially the same as the temperature of the flavor source 33. Therefore, the temperature detection element T1 is a temperature detection element for detecting the temperature of the flavor source 33.

In a configuration in which a constant current flows through the second load 31 when the resistance value of the second load 31 is acquired, the current sensor 53 is unnecessary in the temperature detection element T1. Similarly, in a configuration in which a constant voltage is applied to the second load 31 when the resistance value of the second load 31 is acquired, the voltage sensor 52 is unnecessary in the temperature detection element T1.

As illustrated in FIG. 5, when acquiring the temperature of the second cartridge 30 (flavor source 33), the temperature detection element T1 is preferably provided in the power source unit 10 having the lowest replacement frequency in the aerosol inhaler 1. Accordingly, it is possible to reduce the manufacturing cost of the first cartridge 20 and the second cartridge 30, which have a higher replacement frequency than that of the power source unit 10, and to provide the first cartridge 20 and the second cartridge 30 to the user at low cost.

The voltage sensor 54 measures a voltage value to be applied to the first load 21 and outputs the voltage value. The current sensor 55 measures a current value flowing through the first load 21 and outputs the current value. An output of the voltage sensor 54 and an output of the current sensor 55 are input to the MCU 50. The processor of the MCU 50 acquires a resistance value of the first load 21 based on the output of the voltage sensor 54 and the output of the current sensor 55, and acquires the temperature of the first load 21 corresponding to the resistance value. In a configuration in which a constant current flows through the first load 21 when the resistance value of the first load 21 is acquired, the current sensor 55 is unnecessary in the temperature detection element T2. Similarly, in a configuration in which a constant voltage is applied to the first load 21 when the resistance value of the first load 21 is acquired, the voltage sensor 54 is unnecessary in the temperature detection element T2.

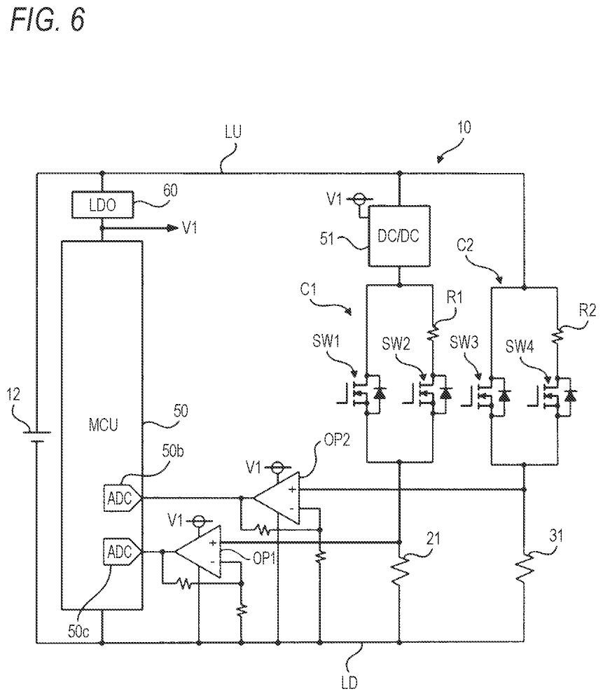

FIG. 6 is a diagram illustrating a specific example of the power source unit 10 illustrated in FIG. 5. FIG. 6 illustrates a specific example of a configuration in which the current sensor 53 is not provided as the temperature detection element T1 and the current sensor 55 is not provided as the temperature detection element T2.

As illustrated in FIG. 6, the power source unit 10 includes: the power source 12; the MCU 50; a low drop out (LDO) regulator 60; a parallel circuit C1 including a switch SW1 and a series circuit of a resistance element R1 and a switch SW2 connected in parallel to the switch SW1; a parallel circuit C2 including a switch SW3 and a series circuit of a resistance element R2 and a switch SW4 connected in parallel to the switch SW3; an operational amplifier OP1 and an analog-to-digital converter (hereinafter, referred to as ADC) 50c that constitute the voltage sensor 54; and an operational amplifier OP2 and an ADC 50b that constitute the voltage sensor 52. At least one of the operational amplifier OP1 and the operational amplifier OP2 may be provided inside the MCU 50.

The resistance element described in the present description may be an element having a fixed electric resistance value, for example, a resistor, a diode, or a transistor. In the example of FIG. 6, each of the resistance element R1 and the resistance element R2 is a resistor.

The switch described in the present description is a switching element such as a transistor that switches between disconnection and conduction of a wiring path, and for example, the switch may be a bipolar transistor such as an insulated gate bipolar transistor (IGBT) or a field effect transistor such as a metal-oxide-semiconductor field-effect transistor (MOSFET). In the example of FIG. 6, each of the switches SW1 to SW4 is a transistor.

The LDO regulator 60 is connected to a main positive bus LU connected to a positive electrode of the power source 12. The MCU 50 is connected to the LDO regulator 60 and a main negative bus LD connected to a negative electrode of the power source 12. The MCU 50 is also connected to each of the switches SW1 to SW4, and controls opening and closing of the switches SW1 to SW4. The LDO regulator 60 steps down the voltage from the power source 12 and outputs the stepped-down voltage. An output voltage V1 of the LDO regulator 60 is also used as an operation voltage of each of the MCU 50, the DC/DC converter 51, the operational amplifier OP1, and the operational amplifier OP2. Alternatively, at least one of the MCU 50, the DC/DC converter 51, the operational amplifier OP1, and the operational amplifier OP2 may use the output voltage of the power source 12 as an operation voltage. Alternatively, at least one of the MCU 50, the DC/DC converter 51, the operational amplifier OP1, and the operational amplifier OP2 may use a voltage output from a regulator (not illustrated) other than the LDO regulator 60 as an operation voltage. The output voltage of the regulator may be different from V1 or may be the same as V1.

The DC/DC converter 51 is connected to the main positive bus LU. The first load 21 is connected to the main negative bus LD. The parallel circuit C1 is connected to the DC/DC converter 51 and the first load 21.

The parallel circuit C2 is connected to the main positive bus LU. The second load 31 is connected to the parallel circuit C2 and the main negative bus LD.

A non-inverting input terminal of the operational amplifier OP1 is connected to a connection node between the parallel circuit C1 and the first load 21. An inverting input terminal of the operational amplifier OP1 is connected to each of an output terminal of the operational amplifier OP1 and the main negative bus LD via a resistance element.

A non-inverting input terminal of the operational amplifier OP2 is connected to a connection node between the parallel circuit C2 and the second load 31. An inverting input terminal of the operational amplifier OP2 is connected to each of an output terminal of the operational amplifier OP2 and the main negative bus LD via a resistance element.

The ADC 50c is connected to the output terminal of the operational amplifier OP1. The ADC 50b is connected to the output terminal of the operational amplifier OP2. The ADC 50c and the ADC 50b may be provided outside the MCU 50.

(MCU)

Next, a function of the MCU 50 will be described. The MCU 50 includes a temperature detection unit, a power control unit, a notification control unit, and a communication control unit as functional units implemented by the processor executing a program stored in advance in a ROM (not illustrated), a memory 50a (see FIG. 5), or the like.

The temperature detection unit acquires the temperature of the flavor source 33 (that is, the temperature of the second load 31) based on the output of the temperature detection element T1. The temperature detection unit acquires the temperature of the first load 21 based on the output of the temperature detection element T2.

In a case of the circuit example illustrated in FIG. 6, the temperature detection unit controls the switch SW1, the switch SW3, and the switch SW4 to be in a disconnection state, and controls the DC/DC converter 51 to output a predetermined constant voltage. Further, the temperature detection unit acquires an output value (a voltage value to be applied to the first load 21) of the ADC 50c in a state where the switch SW2 is controlled to be in a conductive state, and acquires the temperature of the first load 21 based on the output value.

The non-inverting input terminal of the operational amplifier OP1 may be connected to a terminal of the resistance element R1 on a DC/DC converter 51 side, and the inverting input terminal of the operational amplifier OP1 may be connected to a terminal of the resistance element R1 on a switch SW2 side. In this case, the temperature detection unit controls the switch SW1, the switch SW3, and the switch SW4 to be in a disconnection state, and controls the DC/DC converter 51 to output a predetermined constant voltage. Further, the temperature detection unit can acquire an output value (a voltage value to be applied to the resistance element R1) of the ADC 50c in a state where the switch SW2 is controlled to be in a conductive state, and acquire the temperature of the first load 21 based on the output value.

In addition, in the case of the circuit example illustrated in FIG. 6, the temperature detection unit controls the switch SW1, the switch SW2, and the switch SW3 to be in a disconnection state, and controls an element such as a DC/DC converter (not illustrated) so as to output a predetermined constant voltage. Further, the temperature detection unit acquires an output value (a voltage value to be applied to the second load 31) of the ADC 50b in a state where the switch SW4 is controlled to be in a conductive state, and acquires the temperature of the second load 31 as the temperature of the flavor source 33 based on the output value.

The non-inverting input terminal of the operational amplifier OP2 may be connected to a terminal of the resistance element R2 on a main positive bus LU side, and the inverting input terminal of the operational amplifier OP2 may be connected to a terminal of the resistance element R2 on a switch SW4 side. In this case, the temperature detection unit controls the switch SW1, the switch SW2, and the switch SW3 to be in a disconnection state, and controls an element such as a DC/DC converter (not illustrated) so as to output a predetermined constant voltage. Further, the temperature detection unit can acquire an output value (a voltage value to be applied to the resistance element R2) of the ADC 50b in a state where the switch SW4 is controlled to be in the conductive state, and acquire the temperature of the second load 31 as the temperature of the flavor source 33 based on the output value.

The notification control unit controls the notification unit 45 to notify various kinds of information. For example, the notification control unit controls the notification unit 45 to make a notification of prompting a replacement of the second cartridge 30 in response to a detection of a replacement timing of the second cartridge 30. The notification control unit is not limited to make the notification of prompting the replacement of the second cartridge 30, and may make a notification of prompting a replacement of the first cartridge 20, a notification of prompting a replacement of the power source 12, a notification of prompting charging of the power source 12, or the like.

The communication control unit controls the communication unit 46 included in the power source unit 10 so as to communicate various kinds of information between an external communication device 100 and the power source unit 10. The communication device 100 is, for example, a smartphone, a tablet terminal, or the like, and includes an input device (for example, a touch panel) operable by a user, and an output device (for example, various displays including a touch panel) that can notify the user of information. The communication unit 46 is, for example, a network module capable of communicating with the communication device 100 via a predetermined network such as Bluetooth (registered trademark), and functions as an interface for the MCU 50 to communicate with the communication device 100.

The power control unit controls discharge from the power source 12 to the first load 21 (hereinafter, also simply referred to as discharge to the first load 21) and discharge from the power source 12 to the second load 31 (hereinafter, also simply referred to as discharge to the second load 31) according to the signal indicating the aerosol generation request output from the inhalation sensor 15.

In the case of the circuit example illustrated in FIG. 6, the power control unit can perform the discharge to the first load 21 by controlling the switch SW2, the switch SW3, and the switch SW4 to be in the disconnection state and controlling the switch SW1 to be in the conductive state. Thus, the aerosol source 22 can be heated and atomized by the first load 21. In addition, the power control unit can perform the discharge to the second load 31 by controlling the switch SW1, the switch SW2, and the switch SW4 to be in the disconnection state and controlling the switch SW3 to be in the conductive state. Thus, the flavor source 33 can be heated by the second load 31.

As described above, in the aerosol inhaler 1, the flavor source 33 can be heated by the discharge to the second load 31. If power to be supplied to the first load 21 is the same, a flavor component amount to be added to the aerosol can be increased by heating the flavor source 33 as compared with a case where the flavor source 33 is not heated.

A weight [mg] of an aerosol that is generated in the first cartridge 20 and passes through the flavor source 33 by one inhalation operation by the user is referred to as an aerosol weight Wₐₑᵣₒₛₒₗ. Power required to be supplied to the first load 21 for generating the aerosol is referred to as atomized power P_{liquid}. A time during which the atomized power P_{liquid} is supplied to the first load 21 for generating the aerosol is referred to as a supply time tₛₑₙₛₑ. An upper limit value of the supply time tₛₑₙₛₑ is the above-described first predetermined value tᵤₚₚₑᵣ (for example, 2.4 seconds) per inhalation. A weight [mg] of the flavor component contained in the flavor source 33 is referred to as a flavor component remaining amount W_{capsule}. Information on the temperature of the flavor source 33 is referred to as a temperature parameter T_{capsule}. A weight [mg] of a flavor component added to the aerosol that passes through the flavor source 33 by one inhalation operation by the user is referred to as a flavor component amount W_{flavor}. Specifically, the information on the temperature of the flavor source 33 is the temperature of the flavor source 33 or the second load 31 acquired based on the output of the temperature detection element T1.

It is experimentally found that the flavor component amount W_{flavor} depends on the flavor component remaining amount W_{capsule}, the temperature parameter T_{capsule}, and the aerosol weight Wₐₑᵣₒₛₒₗ. Therefore, the flavor component amount W_{flavor} can be modeled by the following Formula (1).

W_{flavor}=β×(W_{capsule}×T_{capsule})×γ×Wₐₑᵣₒₛₒₗ (1)

β in the above-mentioned Formula (1) is a coefficient indicating a ratio of how much of the flavor component contained in the flavor source 33 is added to the aerosol in one inhalation, and is experimentally obtained. γ in the above-mentioned Formula (1) is a coefficient obtained experimentally. The temperature parameter T_{capsule} and the flavor component remaining amount W_{capsule} may vary during a period in which one inhalation is performed, but in this model, γ is introduced in order to handle the temperature parameter T_{capsule} and the flavor component remaining amount W_{capsule} as constant values.

The flavor component remaining amount W_{capsule} decreases every time the inhalation is performed. Therefore, the flavor component remaining amount W_{capsule} is inversely proportional to the number of times of inhalation, which is the number of times inhalation is performed (in other words, an accumulated value of the number of times of the discharge to the first load 21 for aerosol generation in response to the aerosol generation request. Hereinafter, also referred to as an accumulated number of discharge). In addition, the flavor component remaining amount W_{capsule} decreases more as a time during which the discharge to the first load 21 is performed for the aerosol generation in response to the inhalation is longer. Therefore, the flavor component remaining amount W_{capsule} is also inversely proportional to an accumulated value of a time during which the discharge to the first load 21 is performed for the aerosol generation in response to the inhalation (hereinafter, also referred to as an accumulated time of discharge).

As can be seen from the model of the above-mentioned Formula (1), when it is assumed that the aerosol amount Wₐₑᵣₒₛₒₗ for each inhalation is controlled to be substantially constant, in order to stabilize the flavor component amount W_{flavor}, it is necessary to increase the temperature of the flavor source 33 in accordance with a decrease in the flavor component remaining amount W_{capsule} (in other words, an increase in the number of times of inhalation or the accumulated time of discharge).

Therefore, the power control unit increases a target temperature (a target temperature T_{cap_target} described below) of the flavor source 33 based on the number of times of inhalation or the accumulated time of discharge. The power control unit controls the discharge from the power source 12 to the second load 31 based on the output of the temperature detection element T1 such that the temperature of the flavor source 33 converges to the target temperature. Accordingly, it is possible to heat the flavor source 33 to increase and stabilize the flavor component amount W_{flavor}.

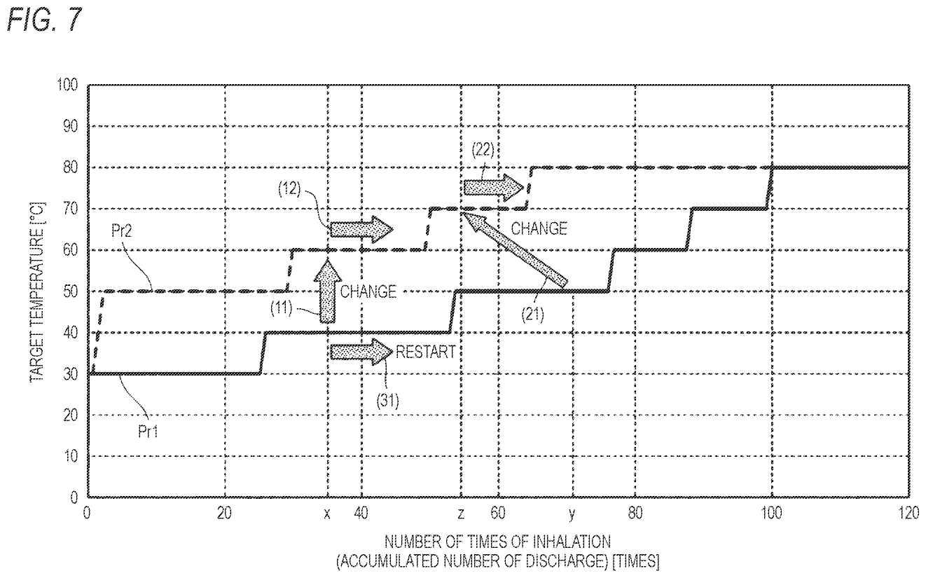

Specifically, the power control unit controls the discharge to the second load 31 in accordance with a control profile stored in advance in the ROM, the memory 50a, or the like. Here, the control profile represents a discharge mode from the power source 12 to the second load 31 according to the number of times of inhalation (that is, the accumulated number of discharge) or the accumulated time of discharge. Although details will be described later with reference to FIG. 7 and the like, in the present embodiment, the control profile is information in which the number of times of inhalation, and the target temperature of the flavor source 33 as an example of a discharge mode to the second load 31 are associated with each other, and the control profile represents the target temperature of the flavor source 33 to be set according to the number of times of inhalation.

Incidentally, as described above, the flavor component amount W_{flavor} to be added to the aerosol can be increased by increasing the temperature of the flavor source 33. Therefore, for example, in a case where the user can appropriately change the target temperature of the flavor source 33, the user can appropriately change the flavor component amount W_{flavor} (that is, inhalation quality). Therefore, for example, it is considered that the user can adjust the flavor component amount W_{flavor} so as to obtain a desired fragrance inhaling taste in consideration of preference of the user, a mood at the time of inhalation, a brand of the second cartridge 30, and the like, and the marketability of the aerosol inhaler 1 is improved.

Therefore, the MCU 50 includes a plurality of control profiles, and controls the discharge to the second load 31 based on any one of the plurality of control profiles. In addition, the MCU 50 can change a control profile used for controlling the discharge to the second load 31 (hereinafter, also referred to as a use control profile) based on a change instruction from the user.

Specifically, for example, the MCU 50 sets a control profile selected by the user as the use control profile via the operation unit 14, the communication device 100, or the like at a timing when the first cartridge 20 or the second cartridge 30 is attached to or detached from (for example, replaced in) the aerosol inhaler 1. In addition, the MCU 50 may automatically set a predetermined control profile among the plurality of control profiles as the use control profile at the timing when the first cartridge 20 or the second cartridge 30 is attached to or detached from the aerosol inhaler 1.

In addition, the user can appropriately execute a change instruction to the MCU 50 via the operation unit 14, the communication device 100, or the like. The change instruction is executed, for example, by the user selecting (specifying) a control profile of a change destination to be newly set as the use control profile. When a change instruction is given, the MCU 50 changes the use control profile to the control profile of the change destination selected by the user, and thereafter controls the discharge to the second load 31 according to the control profile. As a result, the MCU 50 can differ the discharge mode (here, the target temperature of the flavor source 33) to the second load 31 between before the use control profile is changed and after the use control profile is changed. Hereinafter, the change of the control profile will be described in detail.

(Specific Example of Control Profile)

First, a specific example of the control profile will be described with reference to FIG. 7. As illustrated in FIG. 7, the MCU 50 includes a control profile Pr1 and a control profile Pr2. The control profile Pr1 and the control profile Pr2 are implemented by associating the number of times of inhalation with the target temperature of the flavor source 33, and represent the target temperature of the flavor source 33 to be set according to the number of times of inhalation.

Specifically, the control profile Pr1 represents that the target temperature of the flavor source 33 is 30° C. when the number of times of inhalation is 0 to 24, and the target temperature of the flavor source 33 is 40° C. when the number of times of inhalation is 25 to 54. In addition, the control profile Pr1 represents that the target temperature of the flavor source 33 is 50° C. when the number of times of inhalation is 55 to 74, and the target temperature of the flavor source 33 is 60° C. when the number of times of inhalation is 75 to 89. Further, the control profile Pr1 represents that the target temperature of the flavor source 33 is 70° C. when the number of times of inhalation is 90 to 99, and the target temperature of the flavor source 33 is 80° C. when the number of times of inhalation is 100 to 120.

In addition, the control profile Pr2 represents that the target temperature of the flavor source 33 is 50° C. when the number of times of inhalation is 0 to 29, and the target temperature of the flavor source 33 is 60° C. when the number of times of inhalation is 30 to 49. Further, the control profile Pr2 represents that the target temperature of the flavor source 33 is 70° C. when the number of times of inhalation is 50 to 64, and the target temperature of the flavor source 33 is 80° C. when the number of times of inhalation is 65 to 120.

As described above, the target temperature of the flavor source 33 when the number of times of inhalation is 0 to 99 is higher in the control profile Pr2 than in the control profile Pr1. As a result, the MCU 50 can increase the temperature of the flavor source 33 and increase the flavor component amount W_{flavor} in a case where the MCU 50 controls the discharge to the second load 31 according to the control profile Pr2 than in a case where the MCU 50 controls the discharge to the second load 31 according to the control profile Pr1.

Therefore, by selecting the control profile Pr2 as the use control profile, the user can generate an aerosol with stronger inhalation quality (for example, having a so-called strong kick feeling) than when the control profile Pr1 is selected as the use control profile. In other words, by selecting the control profile Pr1 as the use control profile, the user can generate an aerosol with more mild inhalation quality than when the control profile Pr2 is selected as the use control profile.

Here, the control profile Pr1 and the control profile Pr2 represent the target temperature of the flavor source 33 according to the number of times of inhalation, but the present disclosure is not limited thereto. The control profile Pr1 and the control profile Pr2 may be profiles in which the accumulated time of discharge, instead of the number of times of inhalation, is associated with the target temperature of the flavor source 33. In this case, conversion between the accumulated time of discharge and the number of times of inhalation can be performed by, for example, dividing the accumulated time of discharge by the first predetermined value tᵤₚₚₑᵣ, or multiplying the number of times of inhalation by the first predetermined value tᵤₚₚₑᵣ. The number of times of inhalation in the following description can also be converted into the accumulated time of discharge in the same manner.

(Modification Example of Use Control Profile) Next, a modification example of the use control profile will be described. For example, it is assumed that a new first cartridge 20 and a new second cartridge 30 are mounted in the aerosol inhaler 1, and first, the control profile Pr1 is set as the use control profile. Then, it is assumed that inhalation (that is, generation of an aerosol) is performed x times in this state. Here, as an example, x is a natural number of 1 or more. In the following, for easy understanding of the description, an example in which the number of times of inhalation used for control by the MCU 50 is a natural number will be described, but the present disclosure is not limited thereto. For example, as described above, when the MCU 50 performs a control based on the accumulated time of discharge, the number of times of inhalation corresponding to the accumulated time of discharge may not be an integer. Therefore, the number of times of inhalation used for control by the MCU 50 is not limited to a natural number, and may be, for example, a value including a decimal number. Similarly, the possible inhalation number, the possible inhalation time, and the like, which will be described later, may be values including, for example, a decimal number.

It is assumed that, after the inhalation is performed x times, a change instruction of changing the control profile Pr2 to the control profile of the change destination, that is, a change instruction of changing the use control profile to the control profile Pr2 is given. In this case, the MCU 50 changes the use control profile from the control profile Pr1 to the control profile Pr2, for example, as indicated by an arrow (11) in FIG. 7. For example, as indicated by an arrow (12) in FIG. 7, the MCU 50 controls the discharge to the second load 31 according to the control profile Pr2 at the time of generating an aerosol according to an inhalation after the (x+1)th inhalation from when the new first cartridge 20 and the new second cartridge 30 are mounted.

Specifically, in this case, when an aerosol generation request due to the (x+1)th inhalation is given, the MCU 50 sets the target temperature of the flavor source 33 to a temperature corresponding to the number of times of inhalation of (x+1) in the control profile Pr2, and controls the discharge to the second load 31. Thereafter, similarly, when an aerosol generation request due to the (x+j)th (for example, j is a natural number of 2 or more) inhalation is given, the MCU 50 sets the target temperature of the flavor source 33 to a temperature corresponding to the number of times of inhalation of (x+j) in the control profile Pr2, and controls the discharge to the second load 31.

As described above, the MCU 50 does not reset the number of times of inhalation to 0 (zero, that is, an initial value) in accordance with the change of the use control profile, and takes over the number of times of inhalation before the change even after the change of the use control profile. When an aerosol generation request is given after the change of the use control profile, the MCU 50 determines the target temperature of the flavor source 33 based on the number of times of inhalation taken over before the change and the use control profile after the change.

As described above, when the use control profile is changed, the MCU 50 determines the discharge mode to the second load 31 after the change to the control profile of the change destination based on the number of times of inhalation (that is, the accumulated number of discharge to the first load 21) and the control profile of the change destination. As a result, the MCU 50 can determine the discharge mode to the second load 31 after the change to the control profile of the change destination in consideration of the decrease in the flavor component of the flavor source 33 due to the generation of the aerosol before the change to the control profile of the change destination. Therefore, the discharge to the second load 31 can be appropriately controlled even after the change to the control profile of the change destination, and a decrease in the fragrance inhaling taste due to the change of the control profile can be prevented.

In addition, as another example, when the use control profile is changed, the MCU 50 may derive the remaining amount of the flavor component contained in the flavor source 33 (that is, the flavor component remaining amount W_{flavor}) based on the number of times of inhalation (that is, the accumulated number of discharge to the first load 21) or the accumulated time of discharge, and may determine the discharge mode to the second load 31 after the change to the control profile of the change destination based on the derived remaining amount of the flavor component.

Assuming that the weight [mg] of the flavor component contained in the flavor source 33 in a state where the inhalation is performed n_{puff} times (for example, n_{puff} is a natural number of 0 or more) is a flavor component remaining amount W_{capsule} (n_{puff}), the flavor component remaining amount W_{capsule} (n_{puff}) can be modeled by the following Formula (2).

$$\begin{matrix}[ Expression 1 ] & \\ {W}_{capsule} ( {n}_{puff} ) = {W}_{initial} - δ \cdot {\sum }_{i = 1}^{{n}_{puff}} {W}_{flavor} ( i ) & ( 2 )\end{matrix}$$

S in the above-mentioned Formula (2) is a coefficient obtained experimentally. In a period in which one inhalation is performed, the flavor component remaining amount W_{capsule} (n_{puff}) may vary, but in this model, such δ is introduced in order to handle the flavor component remaining amount as a constant value. A flavor component remaining amount W_{capsule} (n_{puff}=0) contained in the flavor source 33 of the new second cartridge 30 is hereinafter also referred to as Wᵢₙᵢₜᵢₐₗ. Wᵢₙᵢₜᵢₐₗ is, for example, a predetermined value determined by a manufacturer or the like of the aerosol inhaler 1. In addition, Wᵢₙᵢₜᵢₐₗ may be different depending on the brand of the second cartridge 30 or the like.

For example, it is assumed that a new first cartridge 20 and a new second cartridge 30 are mounted in the aerosol inhaler 1, and first, the control profile Pr1 is set as the use control profile. Then, it is assumed that inhalation (that is, generation of an aerosol) is performed y times in this state. Here, γ is a natural number of 1 or more. Here, it is assumed that Wy is set as the flavor component remaining amount W_{capsule} (n_{puff}=y) in the case where the inhalation is performed y times with the use control profile as the control profile Pr1. Wy can be obtained based on, for example, the above-mentioned Formula (2).

Thereafter, it is assumed that a change instruction of changing the control profile Pr2 to the control profile of the change destination is given. In this case, the MCU 50 determines how many times of inhalation causes the flavor component remaining amount W_{capsule} to be closest to Wy when the use control profile is the control profile Pr2. Here, as a result of the determination, it is assumed that it is determined that Wz, which is the flavor component remaining amount W_{capsule} (n_{puff}=z) when inhalation is performed z times (for example, z is a natural number of 1 or more, and z≠y) when the use control profile is the control profile Pr2, is a nearest value at which the absolute value of a difference from Wy is minimum, for example, and is equal to the above-mentioned Wy (that is, Wz=Wy) as a specific example.

In this case, the MCU 50 changes the use control profile from the control profile Pr1 to the control profile Pr2, for example, as indicated by an arrow (21) in FIG. 7. For example, as indicated by an arrow (22) in FIG. 7, the MCU 50 controls the discharge to the second load 31 according to the control profile Pr2 at the time of generating an aerosol according to an inhalation after the (y+1)th inhalation from when the new first cartridge 20 and the new second cartridge 30 are mounted.

Specifically, in this case, when an aerosol generation request due to the (y+1)th inhalation is given, the MCU 50 sets the target temperature of the flavor source 33 to a temperature corresponding to the number of times of inhalation of (z+1) in the control profile Pr2, and controls the discharge to the second load 31. Thereafter, similarly, when an aerosol generation request due to the (y+k)th (for example, k is a natural number of 2 or more) inhalation is given, the MCU 50 sets the target temperature of the flavor source 33 to a temperature corresponding to the number of times of inhalation of (z+k) in the control profile Pr2, and controls the discharge to the second load 31.

As described above, when the use control profile is changed, the MCU 50 may determine the discharge mode to the second load 31 after the change to the control profile of the change destination based on the remaining amount of the flavor component contained in the flavor source 33. Accordingly, the discharge mode to the second load 31 after the change to the control profile of the change destination can be determined in consideration of the remaining amount of the flavor component of the flavor source 33 that has decreased due to the generation of the aerosol before the change to the control profile of the change destination. Therefore, the discharge to the second load 31 can be appropriately controlled even after the change to the control profile of the change destination, and a decrease in the fragrance inhaling taste due to the change of the control profile can be prevented.

For example, even under the same conditions of the aerosol weight Wₐₑᵣₒₛₒₗ generated by one inhalation of the user and the temperature of the flavor source 33, it is assumed that the flavor component amount W_{flavor} to be added to the aerosol differs depending on specifications of the tobacco granules (Wᵢₙᵢₜᵢₐₗ corresponding to the brand of the second cartridge 30, a particle size distribution of the tobacco granules, and the like). Therefore, as described above, by determining the discharge mode to the second load 31 after the change to the control profile of the change destination based on the remaining amount of the flavor component contained in the flavor source 33, the MCU 50 can more appropriately control the discharge to the second load 31 even after the change to the control profile of the change destination as compared to a case where the discharge mode to the second load 31 after the change to the control profile of the change destination is determined based on the number of times of inhalation (that is, the accumulated number of discharge to the first load 21) or the accumulated time of discharge.

Further, as described above, by changing the use control profile, the MCU 50 can make the discharge mode (here, the target temperature of the flavor source 33) to the second load 31, which is a control mode load, different before and after the change. In other words, in the aerosol inhaler 1, when the use control profile is changed by the MCU 50, the target temperature of the second load 31, which is the control mode load, and the possible inhalation number or the possible inhalation time after the change may change. Therefore, by changing the use control profile in accordance with preference of the user, a mood at the time of inhalation, or the like, for example, it is possible for the user to realize a desired fragrance inhaling taste, possible inhalation number, possible inhalation time, or the like, and to improve the marketability of the aerosol inhaler 1. Incidentally, the discharge mode of the control mode load that can be changed with the change of the use control profile is not limited to the target temperature of the control mode load, and may be supply power or the like to the control mode load.

(Example when Second Cartridge is Remounted)

For example, for a reason of desiring to change the flavor to be added to the aerosol, it is considered that the user temporarily replaces the second cartridge 30 mounted on the aerosol inhaler 1 with another second cartridge 30, and then remounts the second cartridge 30 mounted before the replacement. That is, it is considered that the second cartridge 30 in which the flavor component remaining amount W_{capsule} is reduced is mounted on the aerosol inhaler 1.

As described above, even in a case where the second cartridge 30 in which the flavor component remaining amount W_{capsule} is reduced is remounted, when the discharge to the second load 31 is controlled in the same manner as in a case where a new second cartridge 30 (that is, the flavor component remaining amount W_{capsule} is not reduced) is mounted, the flavor component amount W_{flavor} is reduced, and the fragrance inhaling taste may be reduced.

Therefore, when the second cartridge 30 that has been mounted on the aerosol inhaler 1 is remounted, the MCU 50 may acquire remaining amount information indicating the flavor component remaining amount W_{capsule} contained in the flavor source 33 of the second cartridge 30, and may determine the discharge mode (that is, the target temperature of the flavor source 33) to the second load 31 after the second cartridge 30 is remounted based on the acquired remaining amount information.

For example, it is assumed that a new first cartridge 20 and a new second cartridge 30 are mounted in the aerosol inhaler 1, and first, the control profile Pr1 is set as the use control profile. Then, it is assumed that inhalation (that is, generation of an aerosol) is performed x times in this state.

Thereafter, it is assumed that, before the (x+1)th inhalation is performed, the above-mentioned second cartridge 30 mounted on the aerosol inhaler 1 is temporarily replaced with another second cartridge 30, and then the above-mentioned second cartridge 30 is remounted on the aerosol inhaler 1.

In this case, when the above-mentioned second cartridge 30 is remounted on the aerosol inhaler 1, the MCU 50 sets the use control profile to the same control profile Pr1 as that in the previous mounting as indicated by an arrow (31) in FIG. 7, and restarts a discharge control to the second load 31 for the (x+1)th time and thereafter in the control profile Pr1. As a result, the discharge mode to the second load 31 after the remounting can be determined in consideration of the remaining amount of the flavor component of the flavor source 33 that has decreased due to the generation of the aerosol before the remounting. Therefore, the discharge to the second load 31 can be appropriately controlled even after the second cartridge 30 is remounted, and a decrease in the fragrance inhaling taste can be prevented.

The MCU 50 may detect attachment/detachment, replacement, or remounting of the first cartridge 20 or the second cartridge 30 using any method. For example, the MCU 50 may detect attachment/detachment, replacement, or remounting of the first cartridge 20 or the second cartridge 30 based on an operation received from the user via the operation unit 14, the communication device 100, or the like.

In addition, for example, the MCU 50 can detect attachment/detachment of the first cartridge 20 based on the electric resistance value between a pair of discharge terminals 41. That is, when the first cartridge 20 is mounted, the first load 21 and the like are electrically connected between the discharge terminals 41, and the discharge terminals 41 are in a conductive state. On the other hand, when the first cartridge 20 is removed, the discharge terminals 41 are in a state of being insulated from each other by air. Therefore, in each of these states, electric resistance values between the discharge terminals 41 that can be acquired by the MCU 50 are different. Therefore, the MCU 50 can detect attachment/detachment of the first cartridge 20 based on the electric resistance value between the discharge terminals 41.

In addition, for example, the MCU 50 can identify each of first cartridges 20 from a difference in the electric resistance value between the discharge terminals 41 when each of the first cartridges 20 is mounted. In addition, instead of the electric resistance value, for example, it is also possible to identify each of the first cartridges 20 by using another physical quantity that can be detected by providing a predetermined sensor, such as a remaining amount of the aerosol source 22 of the first cartridge 20.

Further, for example, if the MCU 50 stores the remaining amount of the aerosol source 22 of each of the first cartridges 20 in the memory 50a or the like, when the first cartridge 20 that has been mounted on the aerosol inhaler 1 is remounted, the MCU 50 can also detect that the first cartridge 20 has been remounted based on the remaining amount of the aerosol source 22 of the first cartridge 20 stored in the memory 50a or the like and a detected remaining amount of the aerosol source 22 of the first cartridge 20.

In addition, for example, when the second cartridge 30 is mounted and detached, stress is applied to the discharge terminal 41 due to the mounting or the detachment. This stress causes fluctuation in the electric resistance value between the pair of discharge terminals 41. Therefore, the MCU 50 may detect attachment/detachment of the second cartridge 30 based on the fluctuation in the electric resistance value between the discharge terminals 41.

In addition, the first cartridge 20 and the second cartridge 30 may be provided with a storage medium storing identification information (for example, an ID) for identifying each of the first cartridge 20 and the second cartridge 30, and the MCU 50 may detect attachment/detachment, replacement, and remounting of the first cartridge 20 or the second cartridge 30 based on the identification information.

For example, when the information stored in these storage media transitions from a state where the information can be acquired (read) by the MCU 50 to a state where the information cannot be acquired by the MCU 50, the MCU 50 detects detachment of the first cartridge 20 or the second cartridge 30. When the information stored in these storage media transitions from the state where the information cannot be acquired by the MCU 50 to the state where the information can be acquired by the MCU 50, the MCU 50 detects mounting of the first cartridge 20 or the second cartridge 30.

In addition, the MCU 50 stores the identification information of the first cartridge 20 or the second cartridge 30 that is mounted in the memory 50a or the like, and can detect that the first cartridge 20 or the second cartridge 30 has been replaced based on a fact that newly acquired identification information has changed from the identification information stored in the memory 50a or the like.

Further, by storing the identification information of the first cartridge 20 or the second cartridge 30 that has been mounted on the aerosol inhaler 1 in the memory 50a or the like, when the first cartridge 20 or the second cartridge 30 that has been mounted on the aerosol inhaler 1 is remounted, the MCU 50 can also detect that these cartridges have been remounted.

For example, by storing the number of times of inhalation (that is, the accumulated number of discharge to the first load 21) or the accumulated time of discharge in a state where the second cartridge 30 is mounted in the memory 50a or the like in association with the identification information of the second cartridge 30 that has been mounted on the aerosol inhaler 1, the MCU 50 can acquire the remaining amount information indicating the flavor component remaining amount W_{capsule} contained in the flavor source 33 of the second cartridge 30.

Similarly, the MCU 50 may store the number of times of inhalation (that is, the accumulated number of discharge to the first load 21) or the accumulated time of discharge in a state where the first cartridge 20 is mounted in the memory 50a or the like in association with the identification information of the first cartridge 20 that has been mounted on the aerosol inhaler 1. In this way, when the first cartridge 20 is remounted, information indicating the remaining amount of the aerosol source 22 of the first cartridge 20 can be acquired. The MCU 50 may determine the discharge mode to the first load 21 or the second load 31 after the remounting of the first cartridge 20 based on the remaining amount of the aerosol source 22 of the remounted first cartridge 20.

(Limitation of Change of Control Profile)

Incidentally, when the control profile is changed during the discharge to the first load 21 (that is, during the generation of the aerosol), the flavor component amount W_{flavor} to be added to the aerosol rapidly varies due to a change in the target temperature of the flavor source 33 caused by the change of the control profile, and may cause an uncomfortable feeling to the user. Such an uncomfortable feeling may lead to a decrease in the marketability of the aerosol inhaler 1.

Therefore, the MCU 50 limits the change of the control profile during discharge to the first load 21. As a result, the MCU 50 can prevent a change of the control profile that may cause an uncomfortable feeling to the user, such as a rapid variation in the flavor component amount W_{flavor} to be added to the aerosol during the inhalation operation by the user. Therefore, the control profile can be appropriately changed, and the marketability of the aerosol inhaler 1 can be improved.

For example, even when a change instruction is received during the discharge to the first load 21, the MCU 50 does not change the control profile based on the change instruction at that time, and changes the control profile based on the above-mentioned change instruction after the discharge to the first load 21 ends. As a result, the MCU 50 can limit the change of the control profile not to be performed during the discharge to the first load 21.

When a change instruction is received via the communication device 100, the MCU 50 may limit the change of the control profile by transmitting, to the communication device 100, information indicating that an operation for executing the change instruction cannot be accepted. Specifically, in this case, when performing the discharge to the first load 21, the MCU 50 transmits, to the communication device 100, the information indicating that the operation for executing the change instruction cannot be accepted. The communication device 100 that has received the information grays out, for example, an operation button for executing a change instruction to be displayed on the touch panel of the communication device 100, and does not receive an operation (that is, an operation for executing a change instruction) performed on the operation button.

As described above, the MCU 50 transmits, to the communication device 100, the information indicating that the operation for executing the change instruction cannot be accepted, so that it is possible to suggest that the operation for executing the change instruction to the user by the communication device 100 cannot be accepted, and the convenience for the user can be improved.

In addition, the MCU 50 may limit the change of the control profile by refusing to receive, from the communication device 100, information indicating that the change instruction is given, or ignoring the information indicating that the change instruction is given, which is received from the communication device 100. As a result, the MCU 50 can limit the change of the control profile with simple control.

(Example of Operation of Aerosol Inhaler 1)

Next, an example of the operation of the aerosol inhaler 1 will be described. Each operation of the aerosol inhaler 1 to be described below can be implemented, for example, by the processor of the MCU 50 executing a program stored in advance in the ROM, the memory 50a, or the like.

(Operation for Generating Aerosol)

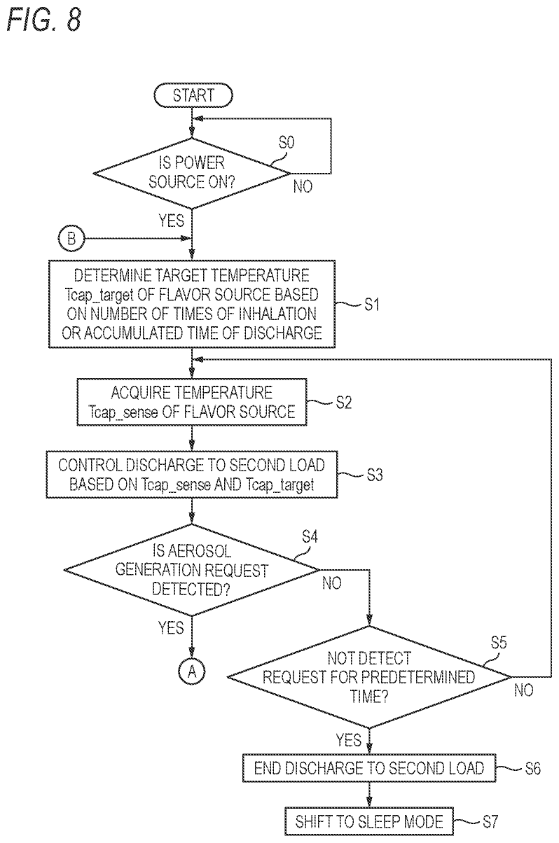

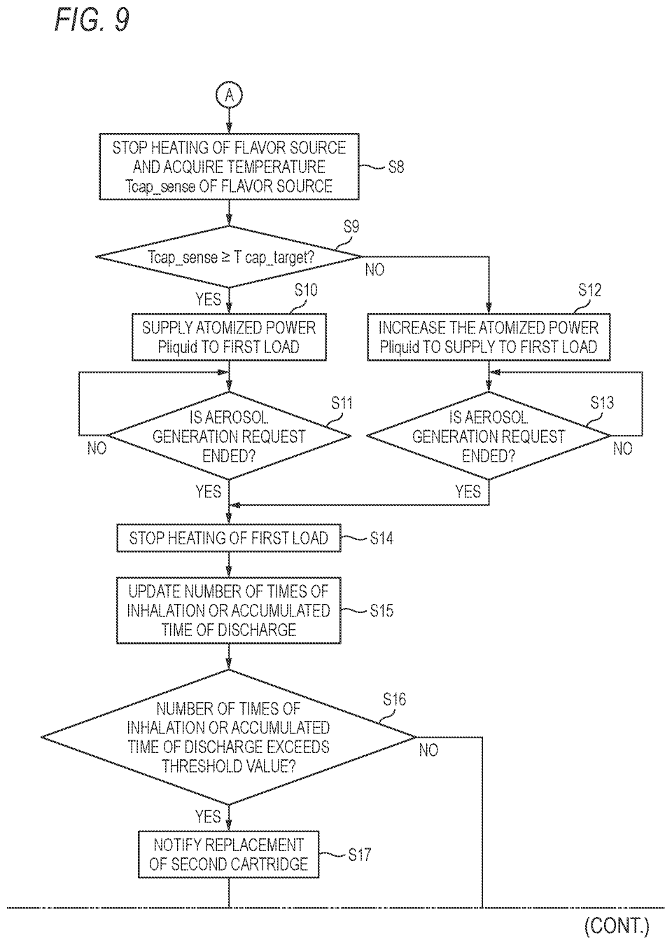

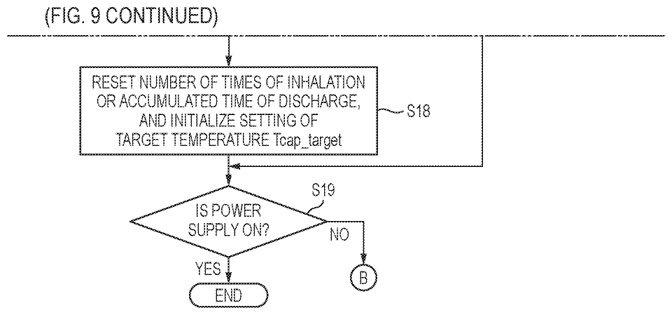

First, an example of an operation for generating an aerosol by the aerosol inhaler 1 will be described with reference to FIGS. 8 and 9. As illustrated in FIG. 8, when the power source of the aerosol inhaler 1 is turned on by the operation of the operation unit 14 or the like (YES in step S0), the MCU 50 determines (sets) the target temperature T_{cap_target} of the flavor source 33 based on the number of times of inhalation or the accumulated time of discharge and the control profile being set (step S1).

Next, the MCU 50 acquires a current temperature T_{cap_sense} of the flavor source 33 based on the output of the temperature detection element T1 (step S2).

Then, the MCU 50 controls the discharge to the second load 31 for heating the flavor source 33 based on the temperature T_{cap_sense} and the target temperature T_{cap_target} (step S3). Specifically, the MCU 50 supplies power to the second load 31 by proportional-integral-differential (PID) control or ON/OFF control such that the temperature T_{cap_sense} converges to the target temperature T_{cap_target}.

In the PID control, a difference between the temperature T_{cap_sense} and the target temperature T_{cap_target} is fed back, and power control is performed based on a feedback result thereof such that the temperature T_{cap_sense} converges to the target temperature T_{cap_target}. According to the PID control, the temperature T_{cap_sense} can converge to the target temperature T_{cap_target} with high accuracy. The MCU 50 may use proportional (P) control or proportional-integral (PI) control instead of the PID control.

The ON/OFF control is a control in which power is supplied to the second load 31 in a state where the temperature T_{cap_sense} is lower than the target temperature T_{cap_target}, and the power supply to the second load 31 is stopped until the temperature T_{cap_sense} becomes lower than the target temperature T_{cap_target} in a state where the temperature T_{cap_sense} is equal to or higher than the target temperature T_{cap_target}. According to the ON/OFF control, the temperature of the flavor source 33 can be increased faster than that in the PID control. Therefore, it is possible to increase a possibility that the temperature T_{cap_sense} reaches the target temperature T_{cap_target} at a stage before an aerosol generation request described later is detected. The target temperature T_{cap_target} may have hysteresis.

After step S3, the MCU 50 determines whether there is an aerosol generation request (step S4). When no aerosol generation request is detected (NO in step S4), the MCU 50 determines a length of a time during which the aerosol generation request is not executed (hereinafter, referred to as non-operation time) in step S5. Then, when the non-operation time has reached a predetermined time (YES in step S5), the MCU 50 ends the discharge to the second load 31 (step S6), and shifts to a sleep mode in which power consumption is reduced (step S7). When the non-operation time is shorter than the predetermined time (NO in step S5), the MCU 50 shifts the process to step S2.

When an aerosol generation request is detected (YES in step S4), the MCU 50 ends the discharge to the second load 31 for heating the flavor source 33, and acquires the temperature T_{cap_sense} of the flavor source 33 at that time based on the output of the temperature detection element T1 (step S8). Then, the MCU 50 determines whether the temperature T_{cap_sense} acquired in step S8 is equal to or higher than the target temperature T_{cap_target} (step S9).

When the temperature T_{cap_sense} is equal to or higher than the target temperature T_{cap_target} (YES in step S9), the MCU 50 supplies a predetermined atomized power P_{liquid} to the first load 21 to start heating of the first load 21 (heating for atomizing the aerosol source 22) (step S10). After the heating of the first load 21 is started in step S10, the MCU 50 continues the heating when the aerosol generation request is not ended (NO in step S11), and stops the power supply to the first load 21 when the aerosol generation request is ended (YES in step S11) (step S14).

When the temperature T_{cap_sense} is lower than the target temperature T_{cap_target} (NO in step S9), the MCU 50 supplies power obtained by increasing the atomized power P_{liquid} by a predetermined amount to the first load 21, and starts the heating of the first load 21 (step S12). The increase in the power here is performed, for example, in accordance with a table in which a temperature difference between the temperature T_{cap_sense} and the target temperature T_{cap_target} is associated with a power increase amount. After the heating of the first load 21 is started in step S12, the MCU 50 continues the heating when the aerosol generation request is not ended (NO in step S13), and stops the power supply to the first load 21 when the aerosol generation request is ended (YES in step S13) (step S14).

Accordingly, even when the temperature of the flavor source 33 does not reach the target temperature at a time when the aerosol generation request is made, an amount of the aerosol to be generated can be increased by performing the process of step S12. As a result, a decrease in the flavor component amount to be added to the aerosol due to the temperature of the flavor source 33 being lower than the target temperature can be compensated for by the increase in the amount of the aerosol. Therefore, the flavor component amount to be added to the aerosol can converge to a target amount.

After step S14, the MCU 50 updates the number of times of inhalation or the accumulated time of discharge stored in the memory 50a (step S15).

Next, the MCU 50 determines whether the updated number of times of inhalation or the updated accumulated time of discharge exceeds a threshold value (step S16). When the updated number of times of inhalation or the updated accumulated time of discharge is equal to or smaller than the threshold value (NO in step S16), the MCU 50 shifts the process to step S19. When the updated number of times of inhalation or the updated accumulated time of discharge exceeds the threshold value (YES in step S16), the MCU 50 causes the notification unit 45 to perform a notification prompting a replacement of the second cartridge 30 (step S17). Then, the MCU 50 resets the number of times of inhalation or the accumulated time of discharge to an initial value (=0), and initializes the target temperature T_{cap_target} (step S18). The initialization of the target temperature T_{cap_target} means excluding a target temperature T_{cap_target} at that time stored in the memory 50a from a set value. As a specific example, when the MCU 50 uses the profile of the target temperature illustrated in FIG. 9, the lowest target temperature (50° C.) may be set as the target temperature T_{cap_target} instead of the initialization. In that case, the process in Step S1 performed immediately after this process may be omitted.

After step S18, the MCU 50 returns the process to step S1 when the power source is not turned off (NO in step S19), and ends the process when the power source is turned off (YES in step S19).

(Operation for Changing Control Profile)

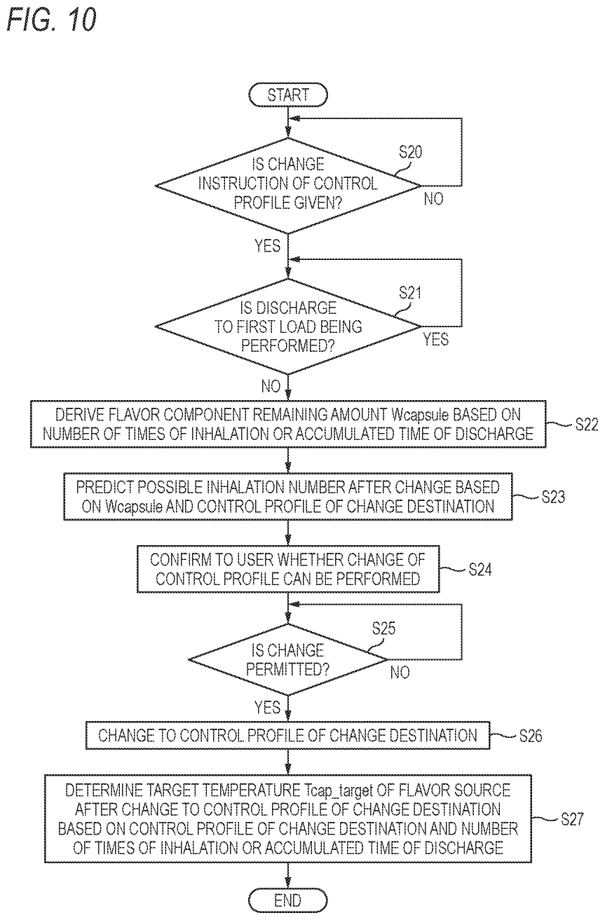

Next, an example of an operation for changing the control profile by the aerosol inhaler 1 will be described with reference to FIG. 10. As illustrated in FIG. 10, when a change instruction of the control profile is given (YES in step S20), the MCU 50 determines whether the discharge to the first load 21 is being performed (that is, whether the atomized power P_{liquid} is supplied to the first load 21) (step S21).

When the discharge to the first load 21 is being performed (YES in step S21), the MCU 50 waits until the discharge to the first load 21 is ended. As a result, the MCU 50 can limit the change of the control profile when the discharge to the first load 21 is being performed.

Here, the MCU 50 waits for the end of the discharge to the first load 21 as long as the discharge to the first load 21 is being performed when a change instruction of the control profile is given, but the present disclosure is not limited thereto. For example, if the discharge to the first load 21 is being performed when a change instruction of the control profile is given, the MCU 50 may notify the user via the communication device 100 that the change of the control profile is not possible, and may end the process illustrated in FIG. 10 as it is. Even in this case, the MCU 50 can limit the change of the control profile when the discharge to the first load 21 is being performed.

As described above, when performing the discharge to the first load 21, the MCU 50 transmits, to the communication device 100, information indicating that an operation for executing a change instruction cannot be accepted, so that the MCU 50 may not accept an operation for executing a change instruction when the discharge to the first load 21 is being performed. Further, when the discharge to the first load 21 is being performed, the MCU 50 may limit the change of the control profile by refusing to receive, from the communication device 100, information indicating that the change instruction is given, or ignoring the information indicating that the change instruction is given received from the communication device 100 and.

On the other hand, when the discharge to the first load 21 is not being performed (NO in step S21), the MCU 50 may directly shift the process to the process of step S26 to perform the change of the control profile, but preferably perform the processes of steps S22 to S25 described below. By performing these processes, the convenience for the user can be improved, and the marketability of the aerosol inhaler 1 can be further improved.

The MCU 50 derives the flavor component remaining amount W_{capsule} contained in the flavor source 33 based on the number of times of inhalation (that is, the accumulated number of discharge to the first load 21) or the accumulated time of discharge (step S22). The flavor component remaining amount W_{capsule} can be obtained based on, for example, the above-mentioned Formula (2).

The MCU 50 predicts a possible inhalation number after the change to the control profile of the change destination based on the flavor component remaining amount W_{capsule} derived in step S22 and the control profile of the change destination (step S23). For example, it is assumed that the control profile of the change destination is the control profile Pr2, and the flavor component remaining amount W_{capsule} is the above-described Wz. In this case, the MCU 50 can predict the possible inhalation number after the change to the control profile Pr2 to be 120 times (upper limit value of the allowable number of times of inhalation in the control profile Pr2) to z times.

Then, for example, the MCU 50 notifies the user of the possible inhalation number predicted in step S22 via the communication device 100, and confirms to the user whether the change of the control profile can be performed (step S24). When the change is permitted by the user (YES in step S25), the MCU 50 performs the change to the control profile of the change destination (step S26).

Then, as described above, the MCU 50 determines the target temperature T_{cap_target} of the flavor source 33 after the change to the control profile of the change destination based on the number of times of inhalation or the accumulated time of discharge and the control profile of the change destination (step S27), and ends the process illustrated in FIG. 10.

When the change is not permitted within a predetermined period after the user confirms whether the control profile can be changed, the MCU 50 may end the process illustrated in FIG. 10 without changing the control profile. In addition, when the user performs an operation of not permitting the change as a result of confirming to the user whether the control profile can be changed, the MCU 50 may end the process illustrated in FIG. 10 without changing the control profile.

As described above, the MCU 50 predicts the possible inhalation number after the change to the control profile of the change destination, and notifies the user of the predicted possible inhalation number, so that the user can be notified of how much inhalation can be performed after the change to the control profile of the change destination. That is, it is also considered that the possible inhalation number is reduced by changing the control profile. Therefore, the MCU 50 notifies the user in advance of the possible inhalation number after the change to the control profile of the change destination, thereby preventing depletion of the flavor component remaining amount W_{capsule} at a timing that is not assumed by the user, and improving the convenience for the user.

The MCU 50 performs the change to the control profile of the change destination when an operation of permitting the change to the control profile of the change destination is performed after the notification of the possible inhalation number, and thus the change of the control profile against an intention of the user can be prevented from being performed. For example, the user may perform an operation of permitting the change to the control profile of the change destination only when the user desires to perform the change to the control profile of the change destination in consideration of the notified possible inhalation number.

Although an embodiment of the present disclosure has been described above with reference to the accompanying drawings, it is needless to say that the present disclosure is not limited to the above-described embodiment. It will be apparent to those skilled in the art that various changes and modifications may be conceived within the scope of the claims, and it is understood that such changes and modifications naturally fall within the technical scope of the present disclosure. Further, respective constituent elements in the embodiment described above may be combined as desired without departing from the gist of the present disclosure.

For example, in the above-described embodiment, the control target load according to the control profile is the second load 31, and the discharge to the second load 31 is controlled by the control profile, but the present disclosure is not limited thereto. For example, the control target load according to the control profile may be the first load 21, and the discharge to the first load 21 may be controlled by the control profile.

Specifically, in this case, the control profile may represent an applied voltage and the atomized power P_{liquid} to the first load 21 when the aerosol generation request is given, instead of the target temperature of the flavor source 33 described above. In this case, the user can change the aerosol weight Wₐₑᵣₒₛₒₗ generated in response to one inhalation operation of the user by changing the control profile. In this case, the user can also change the flavor component amount W_{flavor} to be added to the aerosol generated in response to one inhalation operation of the user by changing the aerosol weight Wₐₑᵣₒₛₒₗ.

Even when the control target load according to the control profile is the first load 21 and the discharge to the first load 21 is controlled by the control profile, the MCU 50 limits the change of the control profile when the discharge to the first load 21 is being performed. Accordingly, the control profile can be appropriately changed, and the marketability of the aerosol inhaler 1 can be improved.

In the above-described embodiment, the control target load according to the control profile is the second load 31, and the MCU 50 limits the change of the control profile when the discharge to the first load 21 is being performed, but the present disclosure is not limited thereto. For example, the control target load according to the control profile may be the second load 31, and the MCU 50 may limit the change of the control profile when the discharge to the second load 31 is being performed. As a specific example, when the flavor source 33 itself also contains the aerosol source 22, the aerosol inhaler 1 may not be provided with the first load 21 but include only the second load 31. In such a case, if the control target load according to the control profile is the second load 31, and the MCU 50 limits the change of the control profile when the discharge to the second load 31 is being performed, the change of the control profile can be appropriately performed, and the marketability of the aerosol inhaler can be improved, as in the above-described embodiment.

Alternatively, both the first load 21 and the second load 31 may be control target loads according to the control profile, and each of the control profile for the first load 21 and the control profile for the second load 31 may be provided. In this way, the user can change the aerosol weight Wₐₑᵣₒₛₒₗ and the flavor component amount W_{flavor} more flexibly.

Further, the control profile may represent a combination of the discharge mode to the first load 21 and the discharge mode to the second load 31. Specifically, in this case, the control profile may represent a combination of the applied voltage to the first load 21 and the target temperature of the flavor source 33 when the aerosol generation request is given. In this way, the user can easily set the discharge modes to the first load 21 and the second load 31 in an appropriate combination.

Further, the user may be allowed to set a desired aerosol weight Wₐₑᵣₒₛₒₗ and a desired flavor component amount W_{flavor}. When the user sets the flavor component amount W_{flavor}, the MCU 50 may automatically set a control profile for the second load 31 capable of realizing the flavor component amount W_{flavor}. Similarly, when the aerosol weight Wₐₑᵣₒₛₒₗ is set by the user, a control profile for the first load 21 capable of realizing the aerosol weight Wₐₑᵣₒₛₒₗ may be automatically set by the MCU 50. Further, in this case, a control profile for the second load 31 for adding an appropriate flavor component to the aerosol having the aerosol weight Wₐₑᵣₒₛₒₗ set by the user may be automatically set by the MCU 50. When the aerosol weight Wₐₑᵣₒₛₒₗ is set by the user and the flavor component amount W_{flavor} is not specified, the MCU 50 may control the discharge to the second load 31 such that the flavor component amount W_{flavor} is the same as that before the aerosol weight Wₐₑᵣₒₛₒₗ is changed according to the setting by the user.

In addition, in the above-described embodiment, the control profile is data in a table format, but the present disclosure is not limited thereto. For example, the control profile may be defined by a predetermined calculation formula. Specifically, for example, in this case, a calculation formula capable of calculating the target temperature of the flavor source 33 to be set according to the aerosol weight Wₐₑᵣₒₛₒₗ, the flavor component amount W_{flavor}, the flavor component remaining amount W_{capsule}, and the like may be provided as the control profile for the second load 31. Similarly, a calculation formula capable of calculating the applied voltage and the atomized power P_{liquid} to the first load 21 to be set according to the aerosol weight Wₐₑᵣₒₛₒₗ, the flavor component amount W_{flavor}, the flavor component remaining amount W_{capsule}, and the like may be provided as the control profile for the first load 21.

Further, different control profiles may be provided for each of the first cartridge 20 and the second cartridge 30, or two control profiles for regular use and for menthol may be provided. For example, here, the control profile for regular use can represent a preferable discharge mode to the first load 21 and the second load 31 when the aerosol source 22 and the flavor source 33 do not contain menthol. In addition, the control profile for menthol can represent a preferable discharge mode to the first load 21 and the second load 31 when the aerosol source 22 and the flavor source 33 contain menthol.

In addition, a calculation formula for calculating the aerosol weight Wₐₑᵣₒₛₒₗ, the flavor component amount W_{flavor}, the flavor component remaining amount W_{capsule}, and the like may be stored in advance in the communication device 100, and information necessary for calculating those may be appropriately transmitted by the MCU 50 to the communication device 100. The MCU 50 may receive, from the communication device 100, information indicating the aerosol weight Wₐₑᵣₒₛₒₗ, the flavor component amount W_{flavor}, the flavor component remaining amount W_{capsule}, and the like calculated by the communication device 100. In this way, an amount of computation of the MCU 50 can be reduced, and the power consumption of the power source unit 10 can be reduced.

In the above-described embodiment, the aerosol inhaler 1 includes the first load 21 and the second load 31, and is implemented to be able to heat both the aerosol source 22 and the flavor source 33, but the present disclosure is not limited thereto. For example, the aerosol inhaler 1 may include the first load 21 that heats the aerosol source 22, but may not include the second load 31 that heats the flavor source 33. In this case, the control profile represents the discharge mode to the first load 21.

In addition, in the above-described embodiment, the user is notified of the possible inhalation number after the change to the control profile of the change destination, but the present disclosure is not limited thereto. For example, the MCU 50 may predict the possible inhalation time after the change to the control profile of the change destination in addition to or instead of the possible inhalation number, and notify the user of the possible inhalation time. Further, the MCU 50 may also notify the user of predetermined information (for example, an intensity of an inhalation quality or a menthol feeling) corresponding to the fragrance inhaling taste after the change of the control profile. For example, when the aerosol weight Wₐₑᵣₒₛₒₗ changes before and after the change of the control profile, the MCU 50 may notify the user of the aerosol weight Wₐₑᵣₒₛₒₗ after the change of the control profile.

In addition, in the above-described embodiment, the MCU 50 obtains the flavor component remaining amount W_{capsule} used for control by deriving the flavor component remaining amount W_{capsule} based on the number of times of inhalation (that is, the accumulated number of discharge to the first load 21), but the present disclosure is not limited thereto. For example, a sensor capable of detecting the flavor component remaining amount W_{capsule} may be provided, and the MCU 50 may acquire the flavor component remaining amount W_{capsule} based on a detection result of the sensor. Similarly, a sensor capable of detecting the remaining amount of the aerosol source 22 may be provided, and the MCU 50 may acquire the remaining amount of the aerosol source 22 based on a detection result of the sensor. That is, the flavor component remaining amount W_{capsule} and the remaining amount of the aerosol source 22 may be acquired via sensors capable of detecting those.

In the above-described embodiment, the first cartridge 20 is implemented to be attachable to and detachable from the power source unit 10, but the first cartridge 20 may be implemented to be integrated with the power source unit 10.

In addition, in the above-described embodiment, the first load 21 and the second load 31 are heaters that generate heat by power discharged from the power source 12, but the first load 21 and the second load 31 may be Peltier elements that can perform both heat generating and cooling by the power discharged from the power source 12. When the first load 21 and the second load 31 are implemented in this manner, the degree of freedom in controlling the temperature of the aerosol source 22 and the temperature of the flavor source 33 is improved, and thus the flavor component amount W_{flavor} and the like can be controlled at a higher level.

In addition, the first load 21 may be implemented by an element capable of atomizing the aerosol source 22 without heating the aerosol source 22 by ultrasonic waves or the like. An element that can be used for the first load 21 is not limited to the above-described heater, Peltier element, and ultrasonic element, and various elements or a combination thereof can be used as long as the elements can atomize the aerosol source 22 by consuming power supplied from the power source 12. Similarly, the second load 31 may be implemented by an element capable of changing the flavor component amount to be added to the aerosol by the flavor source 33 without heating the flavor source 33 by ultrasonic waves or the like. An element that can be used for the second load 31 is not limited to the above-described heater, Peltier element, and ultrasonic element, and various elements or a combination thereof can be used as long as the elements can change the flavor component amount to be added to the aerosol by consuming power supplied from the power source 12.

In the present description, at least the following matters are described. Although corresponding constituent elements or the like in the above embodiment are shown in parentheses, the present disclosure is not limited thereto.

(1) A power source unit (power source unit 10) for an aerosol inhaler (aerosol inhaler 1) causing a flavor source (flavor source 33) to pass through an aerosol generated by heating an aerosol source (aerosol source 22) to add a flavor component of the flavor source to the aerosol, the power source unit including:

a power source (power source 12) capable of discharging to a first load (first load 21) which is a load for heating the aerosol source and a second load (second load 31) which is a load for heating the flavor source; and

a control device (MCU 50) that controls discharge from the power source to a control target load including at least one of the first load and the second load, in the power source unit,

the control device

includes a plurality of control profiles (a control profile Pr1 and a control profile Pr2), controls the discharge to the control target load based on any one of the plurality of control profiles,

is able to change the control profile used for controlling the discharge to the control target load based on a change instruction from a user, and

limits the change of the control profile during discharge to the first load.

According to (1), the change of the control profile is limited during the discharge to the first load, so that it is possible to prevent a change of the control profile that may cause an uncomfortable feeling to the user, such as a rapid variation in a generation amount of the aerosol and an amount of the flavor component to be added to the aerosol during the generation of the aerosol (that is, during an inhalation operation of the user). Therefore, the control profile can be appropriately changed, and the marketability of the aerosol inhaler can be improved.

(2) A power source unit (power source unit 10) for an aerosol inhaler (aerosol inhaler 1) causing a flavor source (flavor source 33) to pass through an aerosol generated by heating an aerosol source (aerosol source 22) to add a flavor component of the flavor source to the aerosol, the power source unit including:

a power source (power source 12) capable of discharging to a load (first load 21) for heating the aerosol source; and

a control device (MCU 50) that controls discharge from the power source to a control target load including the load, in the power source unit,

the control device

includes a plurality of control profiles (a control profile Pr1 and a control profile Pr2), controls the discharge to the control target load based on any one of the plurality of control profiles,

is able to change the control profile used for controlling the discharge to the control target load based on a change instruction from a user, and

limits the change of the control profile during discharge to the load.

According to (2), the change of the control profile is limited during the discharge to the load for heating the aerosol source, so that it is possible to prevent a change of the control profile that may cause an uncomfortable feeling to the user, such as a rapid variation in a generation amount of the aerosol and an amount of the flavor component to be added to the aerosol during the generation of the aerosol (that is, during an inhalation operation of the user). Therefore, the control profile can be appropriately changed, and the marketability of the aerosol inhaler can be improved.

(3) The power source unit for an aerosol inhaler according to (1) or (2), in which

the control device

determines, when the control profile used for controlling the discharge to the control target load is changed, a discharge mode to the control target load after the change to a control profile of a change destination based on the control profile of the change destination and an accumulated number of discharge or an accumulated time of discharge from the power source to the load for heating the aerosol source.

According to (3), when the control profile used for controlling the discharge to the control target load is changed, the discharge mode to the control target load after the change to the control profile of the change destination is determined based on the control profile of the change destination and the accumulated number of discharge or the accumulated time of discharge to the load for heating the aerosol source. As a result, the discharge mode to the control target load after the change to the control profile of the change destination can be determined in consideration of a decrease in the flavor component of the aerosol source or the flavor source due to the generation of the aerosol before the change to the control profile of the change destination. Therefore, the discharge to the control target load can be appropriately controlled even after the change to the control profile of the change destination, and a decrease in the fragrance inhaling taste due to the change of the control profile can be prevented.

(4) The power source unit for an aerosol inhaler according to any one of (1) to (3), in which

the control device

determines, when the control profile used for controlling the discharge to the control target load is changed, a discharge mode to the control target load after the change to a control profile of a change destination based on a remaining amount of the aerosol source or a remaining amount of a flavor component contained in the flavor source.

According to (4), when the control profile used for controlling the discharge to the control target load is changed, the discharge mode to the control target load after the change to the control profile of the change destination is determined based on the remaining amount of the aerosol source or the remaining amount of the flavor component contained in the flavor source. As a result, the discharge mode to the control target load after the change to the control profile of the change destination can be determined in consideration of the remaining amount of the flavor component of the aerosol source or the flavor source that has decreased due to the generation of the aerosol before the change to the control profile of the change destination. Therefore, the discharge to the control target load can be appropriately controlled even after the change to the control profile of the change destination, and a decrease in the fragrance inhaling taste due to the change of the control profile can be prevented.

(5) The power source unit for an aerosol inhaler according to (1) or (2), in which

the control device

predicts, when the change instruction is given, a possible inhalation number or a possible inhalation time after the change to a control profile of a change destination based on the control profile of the change destination and the remaining amount of the aerosol source or the remaining amount of the flavor component contained in the flavor source, and notifies the user of an estimated possible inhalation number or possible inhalation time.

According to (5), when the change instruction is given, the possible inhalation number or the possible inhalation time after the change to the control profile of the change destination is predicted, and the predicted possible inhalation number or possible inhalation time can be notified to the user. As a result, the user can be notified in advance of how much inhalation can be performed after the change to the control profile of the change destination, and thus the convenience for the user can be improved.

(6) The power source unit for an aerosol inhaler according to (5), in which

the control device

performs the change to the control profile of the change destination when an operation of permitting the change to the control profile of the change destination is performed after the possible inhalation number or the possible inhalation time is notified.

According to (6), the change to the control profile of the change destination is performed when an operation of permitting the change to the control profile of the change destination is performed after the notification of the possible inhalation number and the possible inhalation time, and thus the change of the control profile against an intention of the user can be prevented from being performed.

(7) The power source unit for an aerosol inhaler according to (1) or (2), in which

a cartridge (second cartridge 30) for accommodating the flavor source is implemented to be attachable and detachable, and

the control device

determines, when the cartridge is remounted, a discharge mode to the control target load after the cartridge is remounted based on remaining amount information indicating a remaining amount of a flavor component contained in the flavor source accommodated in the cartridge.

According to (7), when the cartridge accommodating the flavor source is remounted, the discharge mode to the control target load after the cartridge is remounted is determined based on the remaining amount information indicating the remaining amount of the flavor component contained in the flavor source accommodated in the cartridge. As a result, the discharge mode to the control target load after the remounting can be determined in consideration of the remaining amount of the flavor component of the flavor source that has decreased due to the generation of the aerosol before the remounting. Therefore, the discharge to the control target load can be appropriately controlled even after the cartridge is remounted.

(8) The power source unit for an aerosol inhaler according to (1) or (2), in which

a cartridge (first cartridge 20) for accommodating the aerosol source is implemented to be attachable and detachable, and

the control device

determines, when the cartridge is remounted, a discharge mode to the control target load after the cartridge is remounted based on remaining amount information indicating a remaining amount of the aerosol source accommodated in the cartridge.

According to (8), when the cartridge accommodating the aerosol source is remounted, the discharge mode to the control target load after the cartridge is remounted is determined based on the remaining amount information indicating the remaining amount of the aerosol source accommodated in the cartridge. As a result, the discharge mode to the control target load after the remounting can be determined in consideration of the remaining amount of the aerosol source that has decreased due to the generation of the aerosol before the remounting. Therefore, the discharge to the control target load can be appropriately controlled even after the cartridge is remounted.

(9) The power source unit for an aerosol inhaler according to (1) or (2), in which

the power source unit is implemented to be capable of communicating with a communication device operable by the user, and is capable of receiving the change instruction via the communication device (communication device 100), and

the control device

limits the change of the control profile by transmitting, to the communication device, information indicating that an operation for executing the change instruction cannot be accepted.

According to (9), the change of the control profile is limited by transmitting, to the communication device operable by the user, the information indicating that an operation for executing the change instruction cannot be accepted. Accordingly, it is possible to suggest that the operation for executing the change instruction to the user by the communication device, which has received the information indicating that the operation for executing the change instruction cannot be accepted, cannot be accepted, and the convenience for the user can be improved.

(10) The power source unit for an aerosol inhaler according to (1) or (2), in which

the power source unit is implemented to be capable of communicating with a communication device operable by the user, and is capable of receiving the change instruction via the communication device (communication device 100), and

the control device

limits the change of the control profile by refusing to receive, from the communication device, information indicating that the change instruction is given, or ignoring the information indicating that the change instruction is given received from the communication device.

According to (10), the change of the control profile can be limited with simple control.

(11) A power source unit (power source unit 10) for an aerosol inhaler (aerosol inhaler 1) causing a flavor source (flavor source 33) to pass through an aerosol generated by heating an aerosol source (aerosol source 22) to add a flavor component of the flavor source to the aerosol, the power source unit including:

a power source (power source 12) capable of discharging to a load (second load 31) for heating the flavor source; and

a control device (MCU 50) that controls discharge from the power source to a control target load including the load, in the power source unit,

the control device

includes a plurality of control profiles (a control profile Pr1 and a control profile Pr2), controls the discharge to the control target load based on any one of the plurality of control profiles,

is able to change the control profile used for controlling the discharge to the control target load based on a change instruction from a user, and

limits the change of the control profile during discharge to the load.

According to (11), the change of the control profile is limited during the discharge to the load for heating the flavor source, so that it is possible to prevent a change of the control profile that may cause an uncomfortable feeling to the user. Therefore, the control profile can be appropriately changed, and the marketability of the aerosol inhaler can be improved.

1. A power source unit for an aerosol inhaler causing a flavor source to pass through an aerosol generated by heating an aerosol source to add a flavor component of the flavor source to the aerosol, the power source unit comprising:
a power source capable of discharging to a first load which is a load for heating the aerosol source and a second load which is a load for heating the flavor source; and
a control device configured to control discharge from the power source to a control target load including at least one of the first load and the second load, wherein:
the control device includes a plurality of control profiles, controls the discharge to the control target load based on any one of the plurality of control profiles;
the control device is able to change the control profile used for controlling the discharge to the control target load based on a change instruction from a user; and
the control device limits the change of the control profile during discharge to the first load.

2. A power source unit for an aerosol inhaler causing a flavor source to pass through an aerosol generated by heating an aerosol source to add a flavor component of the flavor source to the aerosol, the power source unit comprising:
a power source capable of discharging to a load for heating the aerosol source; and
a control device configured to control discharge from the power source to a control target load including the load, wherein:
the control device includes a plurality of control profiles, controls the discharge to the control target load based on any one of the plurality of control profiles;
the control device is able to change the control profile used for controlling the discharge to the control target load based on a change instruction from a user; and
the control device limits the change of the control profile during discharge to the load.

3. The power source unit for an aerosol inhaler according to claim 1, wherein
the control device is configured to determine, when the control profile used for controlling the discharge to the control target load is changed, a discharge mode to the control target load after the change to a control profile of a change destination based on the control profile of the change destination and an accumulated number of discharge or an accumulated time of discharge from the power source to the load for heating the aerosol source.

4. The power source unit for an aerosol inhaler according to claim 1, wherein
the control device is configured to determine, when the control profile used for controlling the discharge to the control target load is changed, a discharge mode to the control target load after the change to a control profile of a change destination based on a remaining amount of the aerosol source or a remaining amount of a flavor component contained in the flavor source.

5. The power source unit for an aerosol inhaler according to claim 1, wherein
the control device is configured to predict, when the change instruction is given, a possible inhalation number or a possible inhalation time after the change to a control profile of a change destination based on the control profile of the change destination and the remaining amount of the aerosol source or the remaining amount of the flavor component contained in the flavor source; and
the control device notify the user of an estimated possible inhalation number or possible inhalation time.

6. The power source unit for an aerosol inhaler according to claim 5, wherein
the control device is configured to perform the change to the control profile of the change destination when an operation of permitting the change to the control profile of the change destination is performed after the possible inhalation number or the possible inhalation time is notified.

7. The power source unit for an aerosol inhaler according to claim 1, wherein:
a cartridge accommodating the flavor source is configured to be attachable and detachable; and
the control device is configured to determine, when the cartridge is remounted, a discharge mode to the control target load after the cartridge is remounted based on remaining amount information indicating a remaining amount of a flavor component contained in the flavor source accommodated in the cartridge.

8. The power source unit for an aerosol inhaler according to claim 1, wherein:
a cartridge accommodating the aerosol source is configured to be attachable and detachable; and
the control device is configured to determine, when the cartridge is remounted, a discharge mode to the control target load after the cartridge is remounted based on remaining amount information indicating a remaining amount of the aerosol source accommodated in the cartridge.

9. The power source unit for an aerosol inhaler according to elitism claim 1, wherein:
the power source unit is configured to be capable of communicating with a communication device operable by the user, and is capable of receiving the change instruction via the communication device; and
the control device is configured to limit the change of the control profile by transmitting, to the communication device, information indicating that an operation for executing the change instruction cannot be accepted.

10. The power source unit for an aerosol inhaler according to claim 1, wherein:
the power source unit is configured to be capable of communicating with a communication device operable by the user, and is capable of receiving the change instruction via the communication device; and
the control device is configured to limit the change of the control profile by refusing to receive, from the communication device, information indicating that the change instruction is given, or ignoring the information indicating that the change instruction is given received from the communication device.

11. A power source unit for an aerosol inhaler causing a flavor source to pass through an aerosol generated by heating an aerosol source to add a flavor component of the flavor source to the aerosol, the power source unit comprising:
a power source capable of discharging to a load for heating the flavor source; and
a control device configured to control discharge from the power source to a control target load including the load, wherein:
the control device includes a plurality of control profiles, controls the discharge to the control target load based on any one of the plurality of control profiles;
the control device is able to change the control profile used for controlling the discharge to the control target load based on a change instruction from a user; and
limits the change of the control profile during discharge to the load.

12. The power source unit for an aerosol inhaler according to claim 2, wherein
the control device is configured to determine, when the control profile used for controlling the discharge to the control target load is changed, a discharge mode to the control target load after the change to a control profile of a change destination based on the control profile of the change destination and an accumulated number of discharge or an accumulated time of discharge from the power source to the load for heating the aerosol source.

13. The power source unit for an aerosol inhaler according to claim 2, wherein
the control device is configured to determine, when the control profile used for controlling the discharge to the control target load is changed, a discharge mode to the control target load after the change to a control profile of a change destination based on a remaining amount of the aerosol source or a remaining amount of a flavor component contained in the flavor source.

14. The power source unit for an aerosol inhaler according to claim 2, wherein
the control device is configured to predict, when the change instruction is given, a possible inhalation number or a possible inhalation time after the change to a control profile of a change destination based on the control profile of the change destination and the remaining amount of the aerosol source or the remaining amount of the flavor component contained in the flavor source; and
the control device notify the user of an estimated possible inhalation number or possible inhalation time.

15. The power source unit for an aerosol inhaler according to claim 2, wherein:
a cartridge accommodating the flavor source is configured to be attachable and detachable; and
the control device is configured to determine, when the cartridge is remounted, a discharge mode to the control target load after the cartridge is remounted based on remaining amount information indicating a remaining amount of a flavor component contained in the flavor source accommodated in the cartridge.

16. The power source unit for an aerosol inhaler according to claim 2, wherein:
a cartridge accommodating the aerosol source is configured to be attachable and detachable; and
the control device is configured to determine, when the cartridge is remounted, a discharge mode to the control target load after the cartridge is remounted based on remaining amount information indicating a remaining amount of the aerosol source accommodated in the cartridge.

17. The power source unit for an aerosol inhaler according to claim 2, wherein:
the power source unit is configured to be capable of communicating with a communication device operable by the user, and is capable of receiving the change instruction via the communication device; and
the control device is configured to limit the change of the control profile by transmitting, to the communication device, information indicating that an operation for executing the change instruction cannot be accepted.

18. The power source unit for an aerosol inhaler according to claim 2, wherein:
the power source unit is configured to be capable of communicating with a communication device operable by the user, and is capable of receiving the change instruction via the communication device; and
the control device is configured to limit the change of the control profile by refusing to receive, from the communication device, information indicating that the change instruction is given, or ignoring the information indicating that the change instruction is given received from the communication device.
